(19) United States
(12) Patent Application Publication
(10) Pub. No.: US 2016/0127866 A1
(43) Pub. Date: May 5, 2016

(54) LOCATION-BASED SERVICE DELIVERING SYSTEM AND LOCATION-BASED SERVICE DELIVERING METHOD FOR PERSON CARRYING MOBILE DEVICE WITH SENSING FUNCTION

(71) Applicant: IADEA CORPORATION, Taipei (TW)

(72) Inventors: Chia-Chin Wang, Taipei City (TW); Juo-Yuan Yang, New Taipei City (TW); Pei-Chi Huang, Taichung City (TW)

(21) Appl. No.: 14/533,026

(22) Filed: Nov. 4, 2014

(51) Int. Cl. H04W 4/02; H04W 4/00

(52) U.S. Cl. CPC H04W 4/023; H04W 4/025; H04W 4/008

(57) ABSTRACT

The present invention provides a location-based service delivering system and method for at least one person carrying a mobile device that can allow the delivery of location-based services without using the earth coordinates. The location-based service delivering system comprises: at least one energy-emitting unit, a tagging unit, at least one display unit, and a control unit. The energy-emitting unit is utilized for emitting at least one energy signal, wherein the mobile device generates at least one sensing signal by sensing the energy signal emitted from the energy-emitting unit. The tagging unit is coupled to the mobile device, and utilized for generating at least one tag associated with the person carrying the mobile device according to the sensing signal. The control unit is coupled to the tagging unit and the display unit, and utilized for controlling the display unit to display information according to the tag generated by the tagging unit.

### BACKGROUND OF THE INVENTION

1. Field of the Invention

The present invention relates to a location-based service delivering system and a location-based service delivering method, and more particularly, to a location-based service delivering system and a location-based service delivering method for at least one person carrying an energy-emitting mobile device or a mobile device with a sensing function that can allow the delivery of location-based services without using the earth coordinates.

2. Description of the Prior Art

In general, the conventional method for location-based services uses coordinates relative to the earth's surface (namely, longitude and latitude, and optionally adding altitude) measured often with GPS signals projected from satellites to determine the location of a person and/or a device, and then deliver services based on the determined location. However, the conventional method fails to work when the person and/or the device is at a location unreachable by satellite signal so that its longitude and latitude cannot be determined.

### SUMMARY OF THE INVENTION

It is therefore one of the objectives of the present invention to provide a location-based service delivering system and a location-based service delivering method for at least one person carrying an energy-emitting mobile device or a mobile device with a sensing function that can allow the delivery of location-based services without using the earth coordinates, so as to solve the above problem.

In accordance with an embodiment of the present invention, a location-based service delivering system for at least one person carrying an energy-emitting mobile device is disclosed. The location-based service delivering system comprises: at least one sensing unit, a tagging unit, at least one display unit, and a control unit. The at least one sensing unit is utilized for generating at least one sensing signal by sensing at least one energy signal emitted from the energy-emitting mobile device. The tagging unit is coupled to the at least one sensing unit, and utilized for generating at least one tag associated with the at least one person carrying the energy-emitting mobile device according to the at least one sensing signal. The control unit is coupled to the tagging unit and the at least one display unit, and utilized for controlling the at least one display unit to display at least one information according to the at least one tag generated by the tagging unit.

In accordance with an embodiment of the present invention, a location-based service delivering method for at least one person carrying an energy-emitting mobile device is disclosed. The location-based service delivering method comprises: utilizing at least one sensing unit for generating at least one sensing signal by sensing at least one energy signal emitted from the energy-emitting mobile device; utilizing a tagging unit for generating at least one tag associated with the at least one person carrying the energy-emitting mobile device according to the at least one sensing signal; and controlling at least one display unit to display at least one information according to the at least one tag generated by the tagging unit.

In accordance with an embodiment of the present invention, a location-based service delivering system for at least one person carrying a mobile device with a sensing function is disclosed. The location-based service delivering system comprises: at least one energy-emitting unit, a tagging unit, at least one display unit, and a control unit. The at least one energy-emitting unit is utilized for emitting at least one energy signal, wherein the mobile device generates at least one sensing signal by sensing the at least one energy signal emitted from the at least one energy-emitting unit. The tagging unit is coupled to the mobile device, and utilized for generating at least one tag associated with the at least one person carrying the mobile device according to the at least one sensing signal. The control unit is coupled to the tagging unit and the at least one display unit, and utilized for controlling the display unit to display at least one information according to the at least one tag generated by the tagging unit.

In accordance with an embodiment of the present invention, a location-based service delivering method for at least one person carrying a mobile device with a sensing function is disclosed. The location-based service delivering method comprises: utilizing the mobile device to generate at least one sensing signal by sensing at least one energy signal emitted from at least one energy-emitting unit; utilizing a tagging unit for generating at least one tag associated with the at least one person carrying the mobile device according to the at least one sensing signal; and controlling at least one display unit to display at least one information according to the at least one tag generated by the tagging unit.

Briefly summarized, the location-based service delivering system and the location-based service delivering method for at least one person carrying an energy-emitting mobile device or a mobile device having a sensing function disclosed by the present invention can use an innovative tagging scheme for the delivery of location-based services and allow the delivery of location-based services without using the earth coordinates. In one scenario, a person carrying an energy-emitting device, such as a mobile phone, can be detected by a plurality of sensing devices installed at fixed locations within a department store, for example. Each sensing device may be associated with at least a semantic tag, such as a name of a retail store, or a brand of a product sold near the receiving station. The person carrying the radio transmitting device is labeled with these tags as he visits different regions of the department store. Then a database of rules may be programmed so that, when the tags of a person carrying the radio transmitting device match sequences in the database, an action is taken where an advertisement is pushed to the person's mobile phone or a screen near the person, for example. In another scenario where the direction of the energy signal is reversed, energy-emitting devices may be installed throughout a store, where each energy-emitting device is associated with at least a semantic tag, such as the name of the store or the brand of the product sold near the transmitter. A person carrying a mobile phone walking around a store may pick up multiple tags. When the sequence of tags matches a previously specified pattern, an action is trigger to play a video on a screen near the person, or to push a message to the person's mobile phone.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a location-based service delivering system for at least one person carrying an energy-emitting mobile device in accordance with a first embodiment of the present invention.

FIG. 2 is a flowchart showing a location-based service delivering method of an embodiment in accordance with the above operation schemes of the location-based service delivering system in FIG. 1 of the present invention.

FIG. 3 shows a simplified block diagram of a location-based service delivering system for at least one person carrying an energy-emitting mobile device in accordance with a second embodiment of the present invention.

FIG. 4 is a flowchart showing a location-based service delivering method of an embodiment in accordance with the above operation schemes of the location-based service delivering system in FIG. 3 of the present invention.

FIG. 5 shows a simplified block diagram of a location-based service delivering system for at least one person carrying an energy-emitting mobile device in accordance with a third embodiment of the present invention.

FIG. 6 is a flowchart showing a location-based service delivering method of an embodiment in accordance with the above operation schemes of the location-based service delivering system in FIG. 5 of the present invention.

FIG. 7 shows a simplified block diagram of a location-based service delivering system for at least one person carrying an energy-emitting mobile device in accordance with a fourth embodiment of the present invention.

FIG. 8 is a flowchart showing a location-based service delivering method of an embodiment in accordance with the above operation schemes of the location-based service delivering system in FIG. 7 of the present invention.

FIG. 9 shows a simplified block diagram of a location-based service delivering system for at least one person carrying a mobile device with a sensing function in accordance with a fifth embodiment of the present invention.

FIG. 10 is a flowchart showing a location-based service delivering method of an embodiment in accordance with the above operation schemes of the location-based service delivering system in FIG. 9 of the present invention.

FIG. 11 shows a simplified block diagram of a location-based service delivering system for at least one person carrying a mobile device with a sensing function in accordance with a sixth embodiment of the present invention.

FIG. 12 is a flowchart showing a location-based service delivering method of an embodiment in accordance with the above operation schemes of the location-based service delivering system in FIG. 11 of the present invention.

FIG. 13 shows a simplified block diagram of a location-based service delivering system for at least one person carrying a mobile device with a sensing function in accordance with a seventh embodiment of the present invention.

FIG. 14 is a flowchart showing a location-based service delivering method of an embodiment in accordance with the above operation schemes of the location-based service delivering system in FIG. 13 of the present invention.

FIG. 15 shows a simplified block diagram of a location-based service delivering system for at least one person carrying a mobile device with a sensing function in accordance with a eighth embodiment of the present invention.

FIG. 16 is a flowchart showing a location-based service delivering method of an embodiment in accordance with the above operation schemes of the location-based service delivering system in FIG. 15 of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

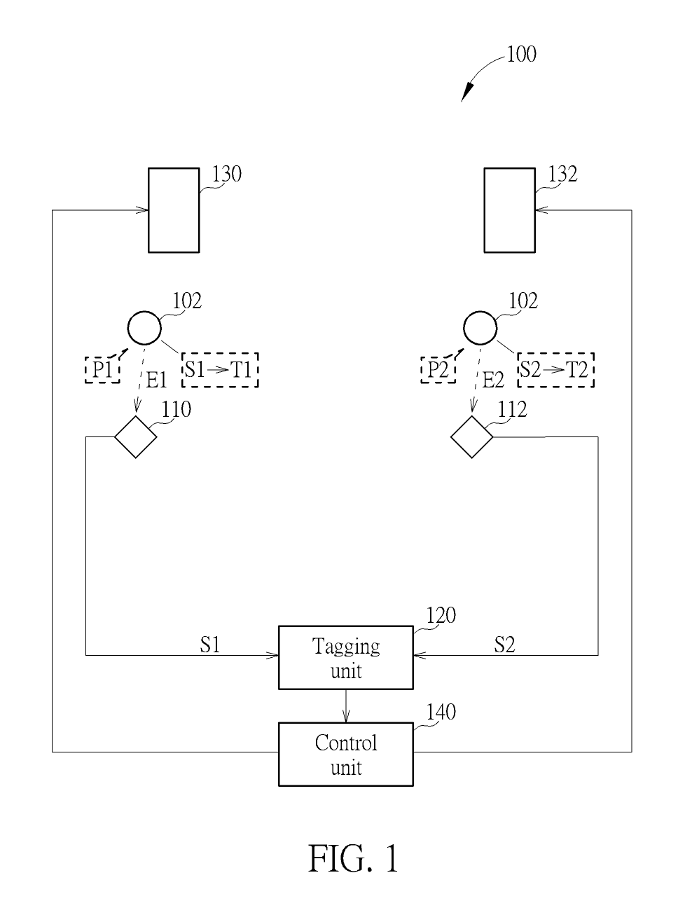

Please refer to FIG. 1. FIG. 1 shows a simplified block diagram of a location-based service delivering system 100 for at least one person carrying an energy-emitting mobile device 102 in accordance with a first embodiment of the present invention. As shown in FIG. 1, the location-based service delivering system 100 comprises: two sensing units 110, 112, a tagging unit 120, two display units 130, 132, and a control unit 140. The sensing units 110 and 112 are utilized for generating at least one sensing signal by sensing at least one energy signal emitted from the energy-emitting mobile device 102, wherein the sensing units 110 and 112 can be disposed at fixed locations within a retail store, a department store, or a mall, etc., and the at least one energy signal can be a Bluetooth radio signal, a WiFi radio signal, a mobile phone radio signal, a pulsating light signal, or an ultrasound signal, etc. The tagging unit 120 is coupled to the sensing units 110 and 112, and utilized for generating at least one tag associated with the at least one person carrying the energy-emitting mobile device 102 according to the at least one sensing signal. The control unit 140 is coupled to the tagging unit 120 and the display units 130 and 132, and utilized for controlling the display units 130 and 132 to display at least one information according to the at least one tag generated by the tagging unit 120, wherein the at least one information can be video, audio, or image, etc., which is for promotion, marketing, or advertisement, etc. In addition, the sensing units 110 and 112 can sense the energy-emitting mobile device 102 by monitoring a MAC address of the energy-emitting mobile device 102. Please note that the above embodiment is only for an illustrative purpose and is not meant to be a limitation of the present invention. For example, the numbers of the person, the energy-emitting mobile device, the sensing unit, and the display unit can be changed according to different conditions. In addition, the tagging unit 120 and/or the control unit 140 can be implemented in a local system or in a cloud system.

For example, as shown in FIG. 1, when a person carrying the energy-emitting mobile device 102 is in a first position point P1 in a department store, the sensing unit 110 will generate a sensing signal S1 by detecting an energy signal E1 emitted from the energy-emitting mobile device 102, and the tagging unit 120 generates a first tag T1 corresponding to the first position point P1 and associated with a person carrying the energy-emitting mobile device 102 according to the sensing signal S1, and the control unit 140 will control the display unit 130 to display a first information according to the first tag T1 when the sensing unit 110 senses that the person carrying the energy-emitting mobile device 102 is near the display unit 130, wherein the first information can be a video, an audio, or an image, etc., which is for promotion, marketing, or advertisement, etc.

Next, when a person carrying the energy-emitting mobile device 102 is in a second position point P2 in the department store, the sensing unit 112 will generate a sensing signal S2 by detecting an energy signal E2 emitted from the energy-emitting mobile device 102, and the tagging unit 120 generates a second tag T2 corresponding to the second position point P2 and associated with the person carrying the energy-emitting mobile device 102 according to the sensing signal S2, and the control unit 140 will control the display unit 130 to display a second information according to the second tag T2, wherein the second information can be a video, an audio, or an image, etc., which is for promotion, marketing, or advertisement, etc. Please note that the above embodiment is only for an illustrative purpose and is not meant to be a limitation of the present invention. For example, the numbers of the person, the energy-emitting mobile device, the sensing unit, and the display unit can be changed according to different conditions.

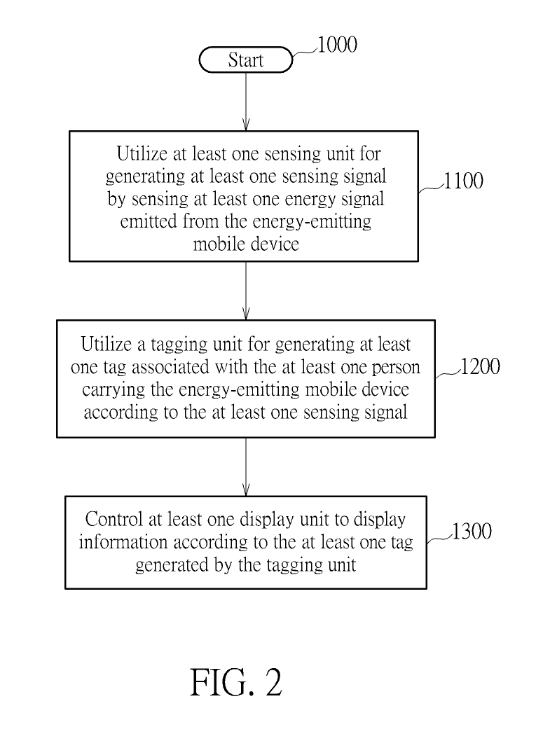

Please refer to FIG. 2. FIG. 2 is a flowchart showing a location-based service delivering method of an embodiment in accordance with the above operation schemes of the location-based service delivering system 100 in FIG. 1 of the present invention. Provided that substantially the same result is achieved, the steps of the process flowchart need not be in the exact order shown in FIG. 2 and need not be contiguous, that is, other steps can be intermediate. The location-based service delivering method in the first embodiment of the present invention comprises the following steps:

Step 1000: Start.

Step 1100: Utilize at least one sensing unit for generating at least one sensing signal by sensing at least one energy signal emitted from the energy-emitting mobile device.

Step 1200: Utilize a tagging unit for generating at least one tag associated with the at least one person carrying the energy-emitting mobile device according to the at least one sensing signal.

Step 1300: Control at least one display unit to display information according to the at least one tag generated by the tagging unit.

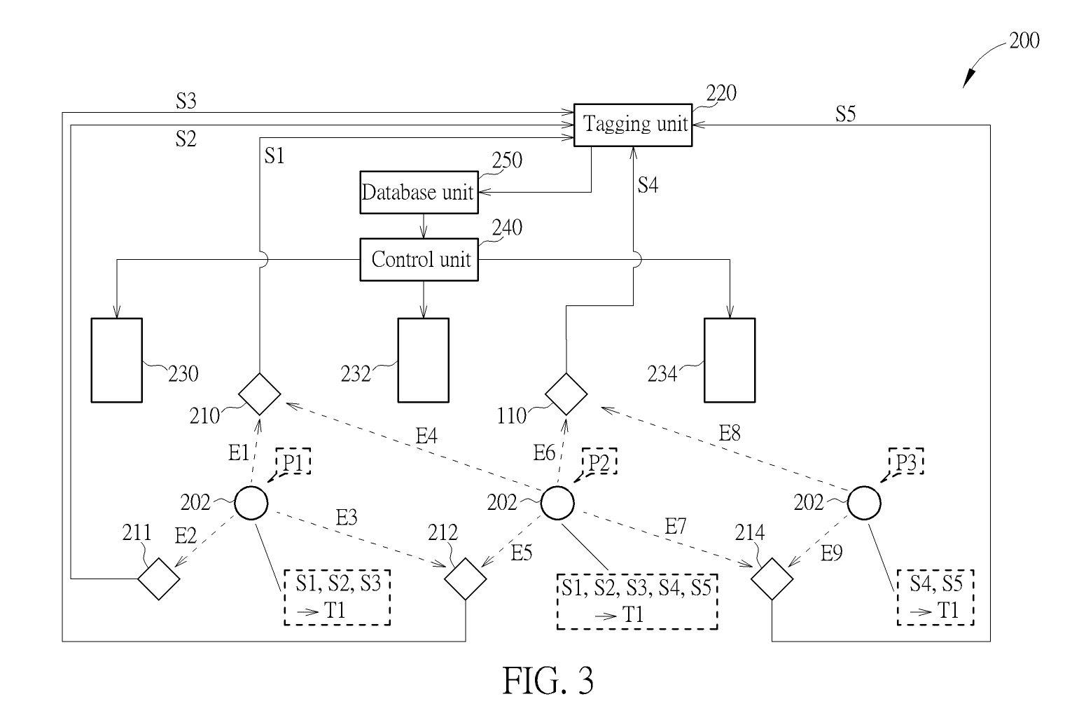

Please refer to FIG. 3. FIG. 3 shows a simplified block diagram of a location-based service delivering system 200 for at least one person carrying an energy-emitting mobile device 202 in accordance with a second embodiment of the present invention. As shown in FIG. 3, the location-based service delivering system 200 comprises: five sensing units 210, 211, 212, 213, 214, a tagging unit 220, three display units 230, 232, 234, a control unit 240, and a database unit 250. The sensing units 210, 211, 212, 213, and 214 are utilized for generating at least one sensing signal by sensing at least one energy signal emitted from the energy-emitting mobile device 202, wherein the sensing units 210, 211, 212, 213, and 214 can be disposed at fixed locations within a retail store, a department store, or a mall, etc., and the at least one energy signal can be a Bluetooth radio signal, a WiFi radio signal, a mobile phone radio signal, a pulsating light signal, or an ultrasound signal, etc. The tagging unit 220 is coupled to the sensing units 210, 211, 212, 213, and 214, and utilized for generating at least one tag associated with the at least one person carrying the energy-emitting mobile device 202 according to the at least one sensing signal. The database unit 250 is coupled to the tagging unit 220 and the control unit 240, and utilized for recording the at least one tag. The control unit 240 is coupled to the tagging unit 220 and the display units 230, 232, and 234, and utilized for controlling the display units 230, 232, and 234 to display at least one information according to the at least one tag recorded in the database unit 250, wherein the at least one information can be video, audio, or image, etc., which is for promotion, marketing, or advertisement, etc. In addition, the sensing units 210, 211, 212, 213, and 214 can sense the energy-emitting mobile device 202 by monitoring a MAC address of the energy-emitting mobile device 202. Please note that the above embodiment is only for an illustrative purpose and is not meant to be a limitation of the present invention. For example, the numbers of the person, the energy-emitting mobile device, the sensing unit, and the display unit can be changed according to different conditions. In addition, the tagging unit 220 and/or the control unit 240 can be implemented in a local system or in a cloud system.

For example, as shown in FIG. 3, when a person carrying the energy-emitting mobile device 202 is in a first position point P1 in a department store, the sensing unit 210 will generate a sensing signal S1 by detecting an energy signal E1 emitted from the energy-emitting mobile device 202, and the sensing unit 211 will generate a sensing signal S2 by detecting an energy signal E2 emitted from the energy-emitting mobile device 202, and the sensing unit 212 will generate a sensing signal S3 by detecting an energy signal E3 emitted from the energy-emitting mobile device 202. The tagging unit 220 generates a first tag T1 corresponding to the first position point P1 and associated with a person carrying the energy-emitting mobile device 202 according to the sensing signal S1, S2, and S3, and the database unit 250 is utilized for recording the first tag T1, and the control unit 240 will control the display unit 230 to display a first information according to the first tag T1 recorded in the database unit 250, wherein the first information can be a video, an audio, or an image, etc., which is for promotion, marketing, or advertisement, etc.

Next, when a person carrying the energy-emitting mobile device 202 is in a second position point P2 in the department store, the sensing unit 210 will generate a sensing signal S1 by detecting an energy signal E4 emitted from the energy-emitting mobile device 202, and the sensing unit 212 will generate a sensing signal S3 by detecting an energy signal E5 emitted from the energy-emitting mobile device 202, and the sensing unit 213 will generate a sensing signal S4 by detecting an energy signal E6 emitted from the energy-emitting mobile device 202, and the sensing unit 214 will generate a sensing signal S5 by detecting an energy signal E7 emitted from the energy-emitting mobile device 202. The tagging unit 220 generates a second tag T2 corresponding to the second position point P2 and associated with the person carrying the energy-emitting mobile device 202 according to the sensing signal S1, S3, S4, and S5, and the database unit 250 is utilized for recording the second tag T2, and the control unit 240 will control the display unit 232 to display a second information according to the second tag T2 and/or the first tag T1 recorded in the database unit 250, wherein the second information can be a video, an audio, or an image, etc., which is for promotion, marketing, or advertisement, etc.

Next, when a person carrying the energy-emitting mobile device 202 is in a third position point P3 in the department store, the sensing unit 213 will generate a sensing signal S4 by detecting an energy signal E8 emitted from the energy-emitting mobile device 202, and the sensing unit 214 will generate a sensing signal S5 by detecting an energy signal E9 emitted from the energy-emitting mobile device 202. The tagging unit 220 generates a third tag T3 corresponding to the third position point P3 and associated with the person carrying the energy-emitting mobile device 202 according to the sensing signal S4 and S5, and the database unit 250 is utilized for recording the third tag T3, and the control unit 240 will control the display unit 234 to display a third information according to the third tag T3, the second tag T2, and/or the first tag T1 recorded in the database unit 250, wherein the third information can be a video, an audio, or an image, etc., which is for promotion, marketing, or advertisement, etc. Please note that the above embodiment is only for an illustrative purpose and is not meant to be a limitation of the present invention. For example, the numbers of the person, the energy-emitting mobile device, the sensing unit, and the display unit can be changed according to different conditions.

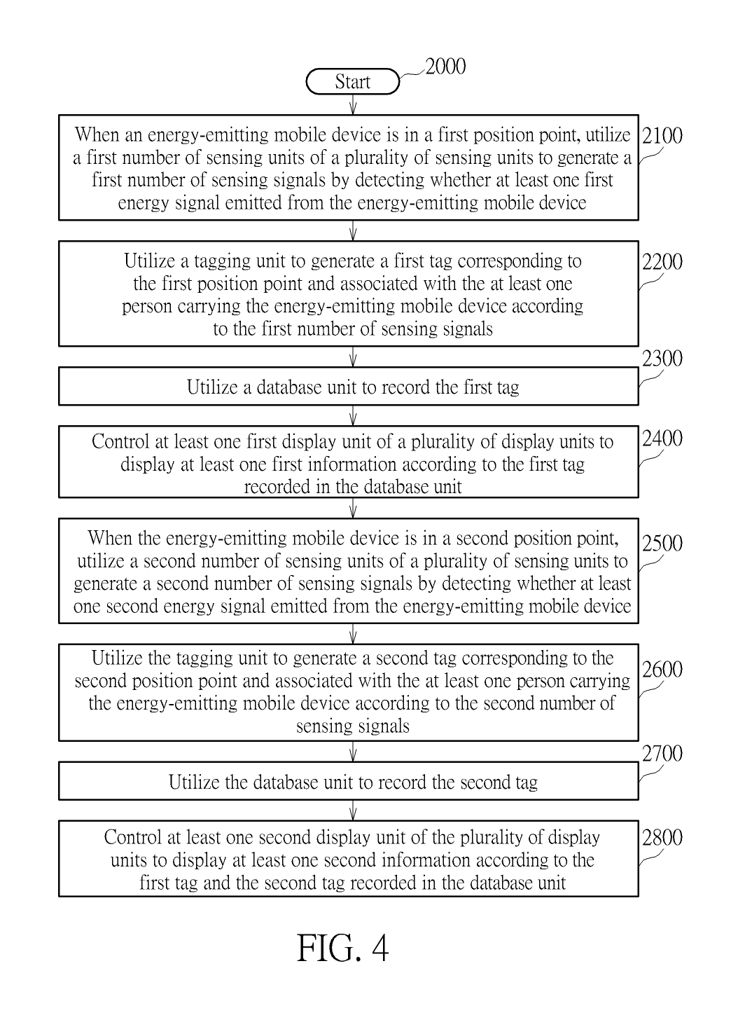

Please refer to FIG. 4. FIG. 4 is a flowchart showing a location-based service delivering method of an embodiment in accordance with the above operation schemes of the location-based service delivering system 200 in FIG. 3 of the present invention. Provided that substantially the same result is achieved, the steps of the process flowchart need not be in the exact order shown in FIG. 4 and need not be contiguous, that is, other steps can be intermediate. The location-based service delivering method in the second embodiment of the present invention comprises the following steps:

Step 2000: Start.

Step 2100: When an energy-emitting mobile device is in a first position point, utilize a first number of sensing units of a plurality of sensing units to generate a first number of sensing signals by detecting whether at least one first energy signal emitted from the energy-emitting mobile device.

Step 2200: Utilize a tagging unit to generate a first tag corresponding to the first position point and associated with the at least one person carrying the energy-emitting mobile device according to the first number of sensing signals.

Step 2300: Utilize a database unit to record the first tag.

Step 2400: Control at least one first display unit of a plurality of display units to display at least one first information according to the first tag recorded in the database unit.

Step 2500: When the energy-emitting mobile device is in a second position point, utilize a second number of sensing units of a plurality of sensing units to generate a second number of sensing signals by detecting whether at least one second energy signal emitted from the energy-emitting mobile device.

Step 2600: Utilize the tagging unit to generate a second tag corresponding to the second position point and associated with the at least one person carrying the energy-emitting mobile device according to the second number of sensing signals.

Step 2700: Utilize the database unit to record the second tag.

Step 2800: Control at least one second display unit of the plurality of display units to display at least one second information according to the first tag and the second tag recorded in the database unit.

Please note that the above embodiment is only for an illustrative purpose and is not meant to be a limitation of the present invention. For example, the number of the position points of the energy-emitting mobile device is not meant to be a limitation of the present invention.

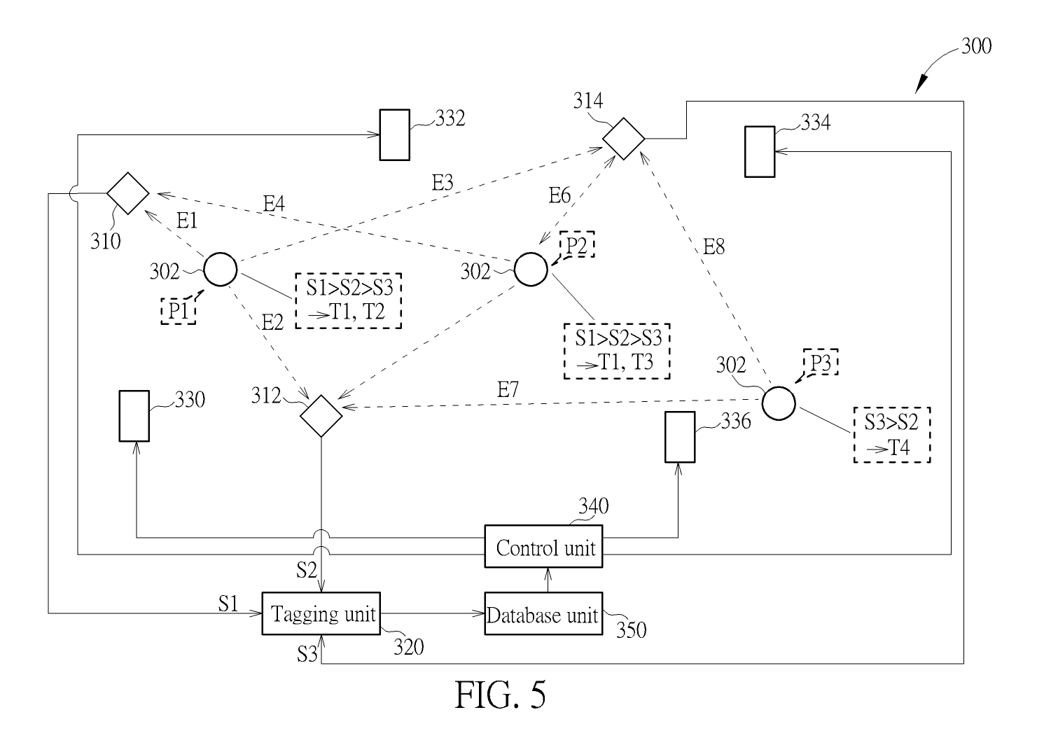

Please refer to FIG. 5. FIG. 5 shows a simplified block diagram of a location-based service delivering system 300 for at least one person carrying an energy-emitting mobile device 302 in accordance with a third embodiment of the present invention. As shown in FIG. 5, the location-based service delivering system 300 comprises: three sensing units 310, 312, 314, a tagging unit 320, four display units 330, 332, 334, a control unit 340, and a database unit 350. The sensing units 310, 312, and 314 are utilized for generating a plurality of sensing signals with different signal strengths or same signal strength by measuring at least one energy signal emitted from the energy-emitting mobile device 302, wherein the sensing units 310, 312, and 314 can be disposed at fixed locations within a retail store, a department store, or a mall, etc., and the at least one energy signal can be a Bluetooth radio signal, a WiFi radio signal, a mobile phone radio signal, a pulsating light signal, or an ultrasound signal, etc. The tagging unit 320 is coupled to the sensing units 310, 312, and 314, and utilized for generating at least one tag associated with the at least one person carrying the energy-emitting mobile device 302 according to the signal strengths of the plurality of sensing signals. The database unit 350 is coupled to the tagging unit 320 and the control unit 340, and utilized for recording the at least one tag. The control unit 340 is coupled to the tagging unit 320 and the display units 330, 332, and 334, and utilized for controlling the display units 330, 332, and 334 to display at least one information according to the at least one tag recorded in the database unit 350, wherein the at least one information can be video, audio, or image, etc., which is for promotion, marketing, or advertisement, etc. In addition, the sensing units 310, 312, and 314 can sense the energy-emitting mobile device 302 by monitoring a MAC address of the energy-emitting mobile device 302. Please note that the above embodiment is only for an illustrative purpose and is not meant to be a limitation of the present invention. For example, the numbers of the person, the energy-emitting mobile device, the sensing unit, and the display unit can be changed according to different conditions. In addition, the tagging unit 320 and/or the control unit 340 can be implemented in a local system or in a cloud system.

For example, as shown in FIG. 5, when a person carrying the energy-emitting mobile device 302 is in a first position point P1 in a department store, the sensing unit 310 will generate a sensing signal S1 with a first signal strength by measuring an energy signal E1 emitted from the energy-emitting mobile device 302, and the sensing unit 312 will generate a sensing signal S2 with a second signal strength by measuring an energy signal E2 emitted from the energy-emitting mobile device 302, and the sensing unit 314 will generate a sensing signal S3 with a third signal strength by measuring an energy signal E3 emitted from the energy-emitting mobile device 302, wherein the first signal strength is higher than the second signal strength, and the second signal strength is higher than the third signal strength (i.e. S1>S2>S3), and the tagging unit 320 generates tags T1 and T2 corresponding to the first position point P1 and associated with a person carrying the energy-emitting mobile device 302 according to the signal strengths of the sensing signal S1, S3, and S3 (i.e. S1>S2>S3), and the database unit 350 is utilized for recording tags T1 and T2, and the control unit 340 will control the display units 330 and 332 to display a first information according to the tag combination (T1 and T2) recorded in the database unit 350, wherein the first information can be a video, an audio, or an image, etc., which is for promotion, marketing, or advertisement, etc.

Next, when a person carrying the energy-emitting mobile device 302 is in a second position point P2 in the department store, the sensing unit 310 will generate a sensing signal S1 with a fourth signal strength by measuring an energy signal E4 emitted from the energy-emitting mobile device 302, and the sensing unit 312 will generate a sensing signal S2 with a fifth signal strength by measuring an energy signal E5 emitted from the energy-emitting mobile device 302, and the sensing unit 314 will generate a sensing signal S3 with a sixth signal strength by measuring an energy signal E6 emitted from the energy-emitting mobile device 302, wherein the sixth signal strength is higher than the fifth signal strength, and the fifth signal strength is higher than the fourth signal strength (i.e. S3>S2>S1), and the tagging unit 320 generates tags T1 and T3 corresponding to the second position point P2 and associated with a person carrying the energy-emitting mobile device 302 according to the signal strengths of the sensing signal S1, S2, and S3 (i.e. S3>S2>S1), and the database unit 350 is utilized for recording the tags T1 and T3, and the control unit 340 will control the display units 334 and 336 to display a second information according to the tag combination (T1 and T3) and/or (T1 and T2) recorded in the database unit 350, wherein the second information can be a video, an audio, or an image, etc., which is for promotion, marketing, or advertisement, etc.

Next, when a person carrying the energy-emitting mobile device 302 is in a third position point P3 in the department store, the sensing unit 312 will generate a sensing signal S2 with a seventh signal strength by measuring an energy signal E7 emitted from the energy-emitting mobile device 302, and the sensing unit 314 will generate a sensing signal S3 with an eighth signal strength by measuring an energy signal E8 emitted from the energy-emitting mobile device 302, wherein the eighth signal strength is higher than the seventh signal strength (i.e. S3>S2), and the tagging unit 320 generates a tag T4 corresponding to the second position point P2 and associated with a person carrying the energy-emitting mobile device 302 according to the signal strengths of the sensing signal S2 and S3 (i.e. S3>S2), and the database unit 350 is utilized for recording the tag T4, and the control unit 340 will control the display units 334 and 336 to display a third information according to the tag T4 and/or the tag combination (T1 and T3) and/or (T1 and T2) recorded in the database unit 350, wherein the third information can be a video, an audio, or an image, etc., which is for promotion, marketing, or advertisement, etc. Please note that the above embodiment is only for an illustrative purpose and is not meant to be a limitation of the present invention. For example, the numbers of the person, the energy-emitting mobile device, the sensing unit, and the display unit can be changed according to different conditions.

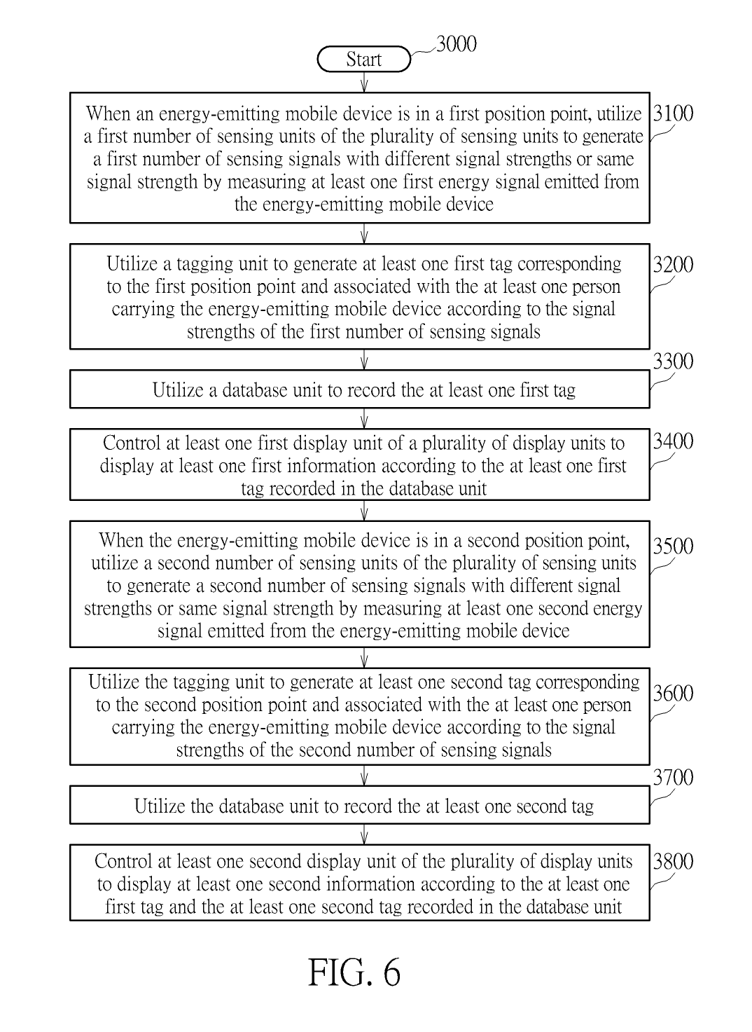

Please refer to FIG. 6. FIG. 6 is a flowchart showing a location-based service delivering method of an embodiment in accordance with the above operation schemes of the location-based service delivering system 300 in FIG. 5 of the present invention. Provided that substantially the same result is achieved, the steps of the process flowchart need not be in the exact order shown in FIG. 6 and need not be contiguous, that is, other steps can be intermediate. The location-based service delivering method in the third embodiment of the present invention comprises the following steps:

Step 3000: Start.

Step 3100: When an energy-emitting mobile device is in a first position point, utilize a first number of sensing units of the plurality of sensing units to generate a first number of sensing signals with different signal strengths or same signal strength by measuring at least one first energy signal emitted from the energy-emitting mobile device.

Step 3200: Utilize a tagging unit to generate at least one first tag corresponding to the first position point and associated with the at least one person carrying the energy-emitting mobile device according to the signal strengths of the first number of sensing signals.

Step 3300: Utilize a database unit to record the at least one first tag.

Step 3400: Control at least one first display unit of a plurality of display units to display at least one first information according to the at least one first tag recorded in the database unit.

Step 3500: When the energy-emitting mobile device is in a second position point, utilize a second number of sensing units of the plurality of sensing units to generate a second number of sensing signals with different signal strengths or same signal strength by measuring at least one second energy signal emitted from the energy-emitting mobile device.

Step 3600: Utilize the tagging unit to generate at least one second tag corresponding to the second position point and associated with the at least one person carrying the energy-emitting mobile device according to the signal strengths of the second number of sensing signals.

Step 3700: Utilize the database unit to record the at least one second tag.

Step 3800: Control at least one second display unit of the plurality of display units to display at least one second information according to the at least one first tag and the at least one second tag recorded in the database unit.

Please note that the above embodiment is only for an illustrative purpose and is not meant to be a limitation of the present invention. For example, the number of the position points of the energy-emitting mobile device is not meant to be a limitation of the present invention.

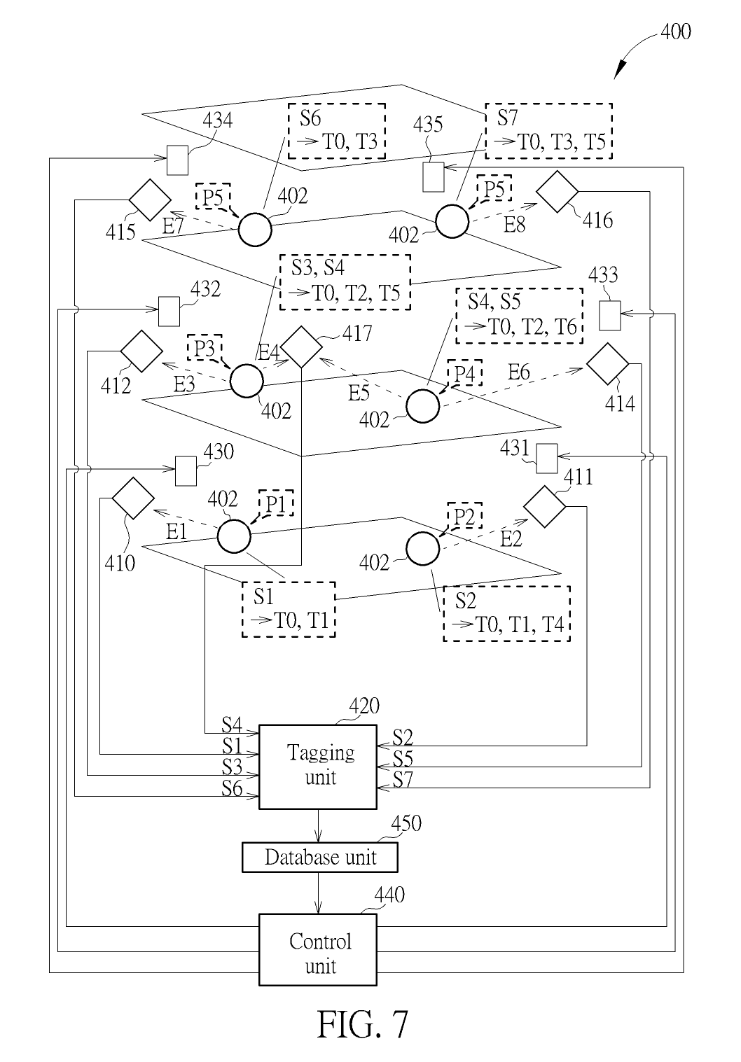

Please refer to FIG. 7. FIG. 7 shows a simplified block diagram of a location-based service delivering system 400 for at least one person carrying an energy-emitting mobile device 402 in accordance with a fourth embodiment of the present invention. As shown in FIG. 7, the location-based service delivering system 400 comprises: seven sensing units 410, 411, 412, 413, 414, 415, 416, a tagging unit 420, six display units 430, 431, 432, 433, 434, 435, a control unit 440, and a database unit 450. The sensing units 410, 411, 412, 413, 414, 415, and 416 are utilized for generating at least one sensing signal by sensing at least one energy signal emitted from the energy-emitting mobile device 402, wherein the sensing units 410, 411, 412, 413, 414, 415, and 416 can be disposed at fixed locations within a retail store, a department store, or a mall, etc., and the at least one energy signal can be a Bluetooth radio signal, a WiFi radio signal, a mobile phone radio signal, a pulsating light signal, or an ultrasound signal, etc. The tagging unit 420 is coupled to the sensing units 410, 411, 412, 413, 414, 415, and 416, and utilized for generating at least one tag associated with the at least one person carrying the energy-emitting mobile device 402 according to the plurality of sensing signals, wherein the at least one tag is pre-defined to be corresponding to a specific position or a specific area, such as a building, a specific floor of the building, or a specific area of the specific floor of the building. The database unit 450 is coupled to the tagging unit 420 and the control unit 440, and utilized for recording the at least one tag. The control unit 440 is coupled to the tagging unit 420 and the display units 430, 431, 432, 433, 434, and 435, and utilized for controlling the display units 430, 431, 432, 433, 434, and 435 to display at least one information according to the at least one tag recorded in the database unit 450, wherein the at least one information can be video, audio, or image, etc., which is for promotion, marketing, or advertisement, etc. In addition, the sensing units 410, 411, 412, 413, 414, 415, and 416 can sense the energy-emitting mobile device 402 by monitoring a MAC address of the energy-emitting mobile device 402. Please note that the above embodiment is only for an illustrative purpose and is not meant to be a limitation of the present invention. For example, the numbers of the person, the energy-emitting mobile device, the sensing unit, and the display unit can be changed according to different conditions. In addition, the tagging unit 420 and/or the control unit 440 can be implemented in a local system or in a cloud system.

For example, as shown in FIG. 7, there are seven tags T0, T1, T2, T3, T4, T5, and T6 pre-defined to be corresponding to a building, a specific floor of the building, and a specific area of the building, respectively, wherein the tag T0 is corresponding to a building of a department store, the tag T1 is corresponding to a first floor of the building of the department store, the tag T2 is corresponding to a second floor of the building of the department store, the tag T3 is corresponding to a third floor of the building of the department store, the tag T4 is corresponding to a cosmetics sales area of the department store, the tag T5 is corresponding to a furniture sales area of the department store, and the tag T6 is corresponding to a clothes sales area of the department store.

When a person carrying the energy-emitting mobile device 402 is in a first position point P1 in a department store, the sensing unit 410 will generate a sensing signal S1 by detecting an energy signal E1 emitted from the energy-emitting mobile device 402, the tagging unit 420 generates the tag T0 corresponding to the building of a department store and the tag T1 corresponding to the first floor of the building of the department store associated with the person carrying the energy-emitting mobile device 402 according to the sensing signal S1, and the database unit 450 is utilized for recording the tags T0 and T1, and the control unit 440 will control the display unit 430 to display a first information according to the tag combination (T0 and T1) recorded in the database unit 450, wherein the first information can be a video, an audio, or an image, etc., which is for promotion, marketing, or advertisement, etc.

Next, when a person carrying the energy-emitting mobile device 402 is in a second position point P2 in the department store, the sensing unit 411 will generate a sensing signal S2 by detecting an energy signal E2 emitted from the energy-emitting mobile device 402, and the tagging unit 420 generates the tag T0 corresponding to the building of a department store, the tag T1 corresponding to the first floor of the building of the department store, and the tag T4 corresponding to the cosmetics sales area of the department store associated with the person carrying the energy-emitting mobile device 402 according to the sensing signal S2, and the database unit 450 is utilized for recording the tags T0, T1, and T4, and the control unit 440 will control the display unit 431 to display a second information according to the tag combination (T0, T1, and T4) and/or (T0 and T1) recorded in the database unit 450, wherein the second information can be a video, an audio, or an image, etc., which is for promotion, marketing, or advertisement, etc.

Next, when a person carrying the energy-emitting mobile device 402 is in a third position point P3 in the department store, the sensing unit 412 will generate a sensing signal S3 by detecting an energy signal E3 emitted from the energy-emitting mobile device 402 and the sensing unit 413 will generate a sensing signal S4 by detecting an energy signal E4 emitted from the energy-emitting mobile device 402, and the tagging unit 420 generates the tag T0 corresponding to the building of a department store, the tag T2 corresponding to the second floor of the building of the department store, and the tag T5 corresponding to the furniture sales area of the department store associated with the person carrying the energy-emitting mobile device 402 according to the sensing signals S3 and S4, and the database unit 450 is utilized for recording the tags T0, T2, and T5, and the control unit 440 will control the display unit 432 to display a third information according to the tag combination (T0, T2, and T5), (T0, T1), and/or (T0, T1, and T4) recorded in the database unit 450, wherein the third information can be a video, an audio, or an image, etc., which is for promotion, marketing, or advertisement, etc.

Next, when a person carrying the energy-emitting mobile device 402 is in a fourth position point P4 in the department store, the sensing unit 413 will generate a sensing signal S4 by detecting an energy signal E5 emitted from the energy-emitting mobile device 402 and the sensing unit 414 will generate a sensing signal S5 by detecting an energy signal E6 emitted from the energy-emitting mobile device 402, and the tagging unit 420 generates the tag T0 corresponding to the building of a department store, the tag T2 corresponding to the second floor of the building of the department store, and the tag T6 corresponding to the clothes sales area of the department store associated with the person carrying the energy-emitting mobile device 402 according to the sensing signals S4 and S5, and the database unit 450 is utilized for recording the tags T0, T2, and T6, and the control unit 440 will control the display unit 433 to display a fourth information according to the tag combination (T0, T2, and T6), (T0, T2, and T5), (T0, T1), and/or (T0, T1, and T4) recorded in the database unit 450, wherein the fourth information can be a video, an audio, or an image, etc., which is for promotion, marketing, or advertisement, etc.

Next, when a person carrying the energy-emitting mobile device 402 is in a fifth position point P5 in the department store, the sensing unit 415 will generate a sensing signal S6 by detecting an energy signal E7 emitted from the energy-emitting mobile device 402, and the tagging unit 420 generates the tag T0 corresponding to the building of a department store, the tag T3 corresponding to the third floor of the building of the department store associated with the person carrying the energy-emitting mobile device 402 according to the sensing signal S6, and the database unit 450 is utilized for recording the tags T0 and T3, and the control unit 440 will control the display unit 434 to display a fifth information according to the tag combination (T0, T3), (T0, T2, and T6), (T0, T2, and T5), (T0, T1), and/or (T0, T1, and T4) recorded in the database unit 450, wherein the fifth information can be a video, an audio, or an image, etc., which is for promotion, marketing, or advertisement, etc.

Next, when a person carrying the energy-emitting mobile device 402 is in a sixth position point P5 in the department store, the sensing unit 416 will generate a sensing signal S7 by detecting an energy signal E8 emitted from the energy-emitting mobile device 402, and the tagging unit 420 generates the tag T0 corresponding to the building of a department store, the tag T3 corresponding to the third floor of the building of the department store, and the tag T5 corresponding to the furniture sales area of the department store associated with the person carrying the energy-emitting mobile device 402 according to the sensing signal S7, and the database unit 450 is utilized for recording the tags T0, T2, and T5, and the control unit 440 will control the display unit 435 to display a sixth information according to the tag combination (T0, T3, and T5), (T0, T3), (T0, T2, and T6), (T0, T2, and T5), (T0, T1), and/or (T0, T1, and T4) recorded in the database unit 450, wherein the sixth information can be a video, an audio, or an image, etc., which is for promotion, marketing, or advertisement, etc.

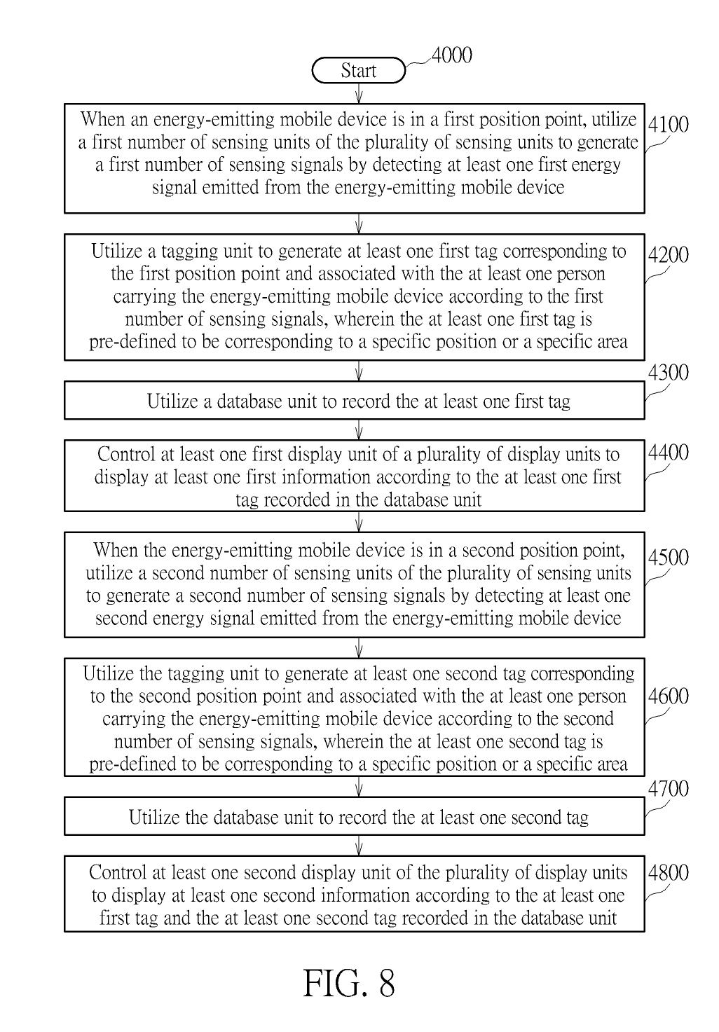

Please refer to FIG. 8. FIG. 8 is a flowchart showing a location-based service delivering method of an embodiment in accordance with the above operation schemes of the location-based service delivering system 200 in FIG. 7 of the present invention. Provided that substantially the same result is achieved, the steps of the process flowchart need not be in the exact order shown in FIG. 4 and need not be contiguous, that is, other steps can be intermediate. The location-based service delivering method in the fourth embodiment of the present invention comprises the following steps:

Step 4000: Start.

Step 4100: When an energy-emitting mobile device is in a first position point, utilize a first number of sensing units of the plurality of sensing units to generate a first number of sensing signals by detecting at least one first energy signal emitted from the energy-emitting mobile device.

Step 4200: Utilize a tagging unit to generate at least one first tag corresponding to the first position point and associated with the at least one person carrying the energy-emitting mobile device according to the first number of sensing signals, wherein the at least one first tag is pre-defined to be corresponding to a specific position or a specific area.

Step 4300: Utilize a database unit to record the at least one first tag.

Step 4400: Control at least one first display unit of a plurality of display units to display at least one first information according to the at least one first tag recorded in the database unit.

Step 4500: When the energy-emitting mobile device is in a second position point, utilize a second number of sensing units of the plurality of sensing units to generate a second number of sensing signals by detecting at least one second energy signal emitted from the energy-emitting mobile device.

Step 4600: Utilize the tagging unit to generate at least one second tag corresponding to the second position point and associated with the at least one person carrying the energy-emitting mobile device according to the second number of sensing signals, wherein the at least one second tag is pre-defined to be corresponding to a specific position or a specific area.

Step 4700: Utilize the database unit to record the at least one second tag.

Step 4800: Control at least one second display unit of the plurality of display units to display at least one second information according to the at least one first tag and the at least one second tag recorded in the database unit.

Please note that the above embodiment is only for an illustrative purpose and is not meant to be a limitation of the present invention. For example, the number of the position points of the energy-emitting mobile device is not meant to be a limitation of the present invention.

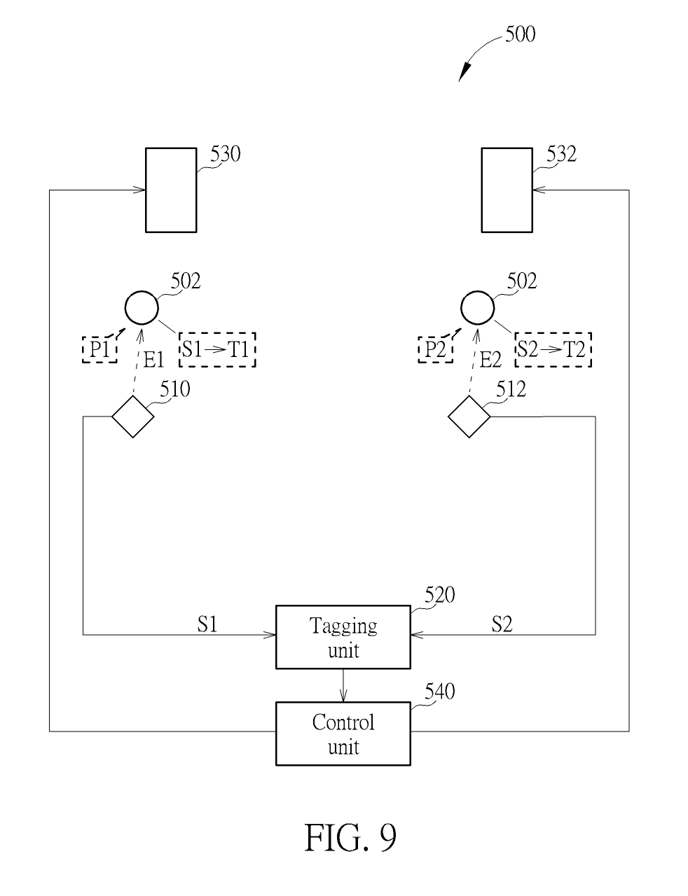

Please refer to FIG. 9. FIG. 9 shows a simplified block diagram of a location-based service delivering system 500 for at least one person carrying a mobile device 502 with a sensing function in accordance with a fifth embodiment of the present invention. As shown in FIG. 9, the location-based service delivering system 500 comprises: two energy-emitting units 510, 512, a tagging unit 520, two display units 530, 532, and a control unit 540. The mobile device 502 is utilized for generating at least one sensing signal by sensing at least one energy signal emitted from the energy-emitting units 510 and 512, wherein the energy-emitting units 510 and 512 can be disposed at fixed locations within a retail store, a department store, or a mall, etc., and the at least one energy signal can be a Bluetooth radio signal, a WiFi radio signal, a mobile phone radio signal, a pulsating light signal, or an ultrasound signal, etc. The tagging unit 520 is coupled to the mobile device 502, and utilized for generating at least one tag associated with the at least one person carrying the mobile device 502 according to the at least one sensing signal. The control unit 540 is coupled to the tagging unit 520 and the display units 530 and 532, and utilized for controlling the display units 530 and 532 to display at least one information according to the at least one tag generated by the tagging unit 520, wherein the at least one information can be video, audio, or image, etc., which is for promotion, marketing, or advertisement, etc. Please note that the above embodiment is only for an illustrative purpose and is not meant to be a limitation of the present invention. For example, the numbers of the person, the mobile device, the energy-emitting unit, and the display unit can be changed according to different conditions. In addition, the tagging unit 520 and/or the control unit 540 can be implemented in a local system or in a cloud system. More specifically, the tagging unit 520 and/or the control unit 540 can be integrated in the mobile device 502. Moreover, the functions of the display units 530, 532 can be replaced by the mobile device 502 when the design requirement of the location-based service delivering system 500 is making the mobile device 502 display at least one information according to the at least one tag. In other words, the display units 530, 532 can be integrated in the mobile device 502 or omitted in another embodiment.

For example, as shown in FIG. 9, when a person carrying the mobile device 502 is in a first position point P1 in a department store, the mobile device 502 will generate a sensing signal S1 by detecting an energy signal E1 emitted from the energy-emitting unit 510, and the tagging unit 520 generates a first tag T1 corresponding to the first position point P1 and associated with a person carrying the mobile device 502 according to the sensing signal S1, and the control unit 540 will control the display unit 530 to display a first information according to the first tag T1 when the energy-emitting unit 510 senses that the person carrying the mobile device 502 is near the display unit 530, wherein the first information can be a video, an audio, or an image, etc., which is for promotion, marketing, or advertisement, etc.

Next, when a person carrying the mobile device 502 is in a second position point P2 in the department store, the mobile device 502 will generate a sensing signal S2 by detecting an energy signal E2 emitted from the energy-emitting unit 512, and the tagging unit 520 generates a second tag T2 corresponding to the second position point P2 and associated with the person carrying the mobile device 502 according to the sensing signal S2, and the control unit 540 will control the display unit 530 to display a second information according to the second tag T2, wherein the second information can be a video, an audio, or an image, etc., which is for promotion, marketing, or advertisement, etc. Please note that the above embodiment is only for an illustrative purpose and is not meant to be a limitation of the present invention. For example, the numbers of the person, the mobile device, the energy-emitting unit, and the display unit can be changed according to different conditions.

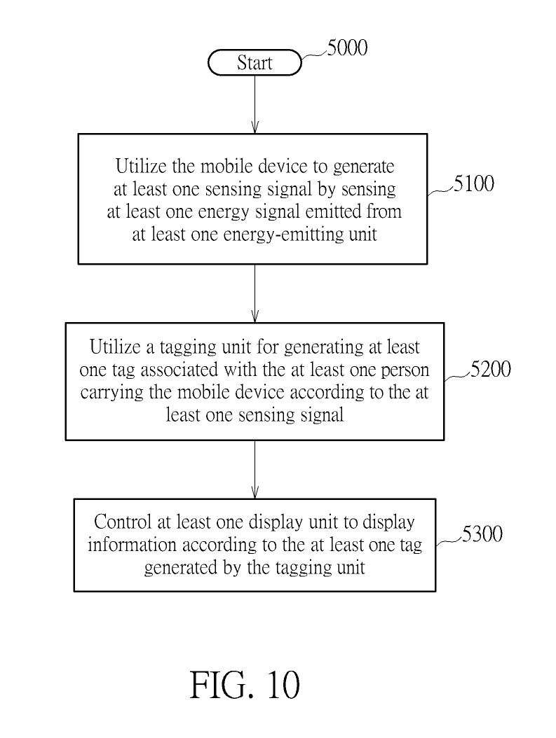

Please refer to FIG. 10. FIG. 10 is a flowchart showing a location-based service delivering method of an embodiment in accordance with the above operation schemes of the location-based service delivering system 500 in FIG. 9 of the present invention. Provided that substantially the same result is achieved, the steps of the process flowchart need not be in the exact order shown in FIG. 10 and need not be contiguous, that is, other steps can be intermediate. The location-based service delivering method in the fifth embodiment of the present invention comprises the following steps:

Step 5000: Start.

Step 5100: Utilize the mobile device to generate at least one sensing signal by sensing at least one energy signal emitted from at least one energy-emitting unit.

Step 5200: Utilize a tagging unit for generating at least one tag associated with the at least one person carrying the mobile device according to the at least one sensing signal.

Step 5300: Control at least one display unit to display information according to the at least one tag generated by the tagging unit.

Please note that the above embodiment is only for an illustrative purpose and is not meant to be a limitation of the present invention. For example, the tagging unit can be integrated in the mobile device 502. Moreover, the functions of the at least one display unit can be replaced by the mobile device when the design requirement of the location-based service delivering method is making the mobile device display the at least one information according to the at least one tag. In other words, the at least one display unit can be integrated in the mobile device in another embodiment.

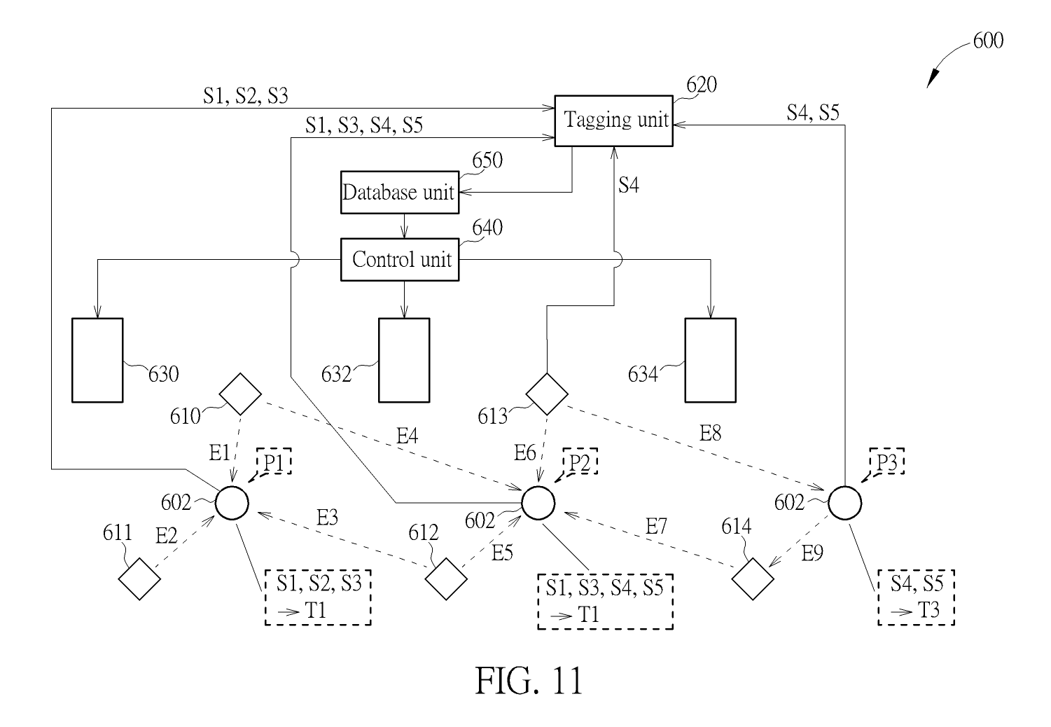

Please refer to FIG. 11. FIG. 11 shows a simplified block diagram of a location-based service delivering system 600 for at least one person carrying a mobile device 602 with a sensing function in accordance with a sixth embodiment of the present invention. As shown in FIG. 11, the location-based service delivering system 600 comprises: five energy-emitting units 610, 611, 616, 613, 614, a tagging unit 620, three display units 630, 632, 634, a control unit 640, and a database unit 650. The mobile device 602 is utilized for generating at least one sensing signal by sensing at least one energy signal emitted from the energy-emitting units 610, 611, 612, 613, and 614, wherein the energy-emitting units 610, 611, 612, 613, and 614 can be disposed at fixed locations within a retail store, a department store, or a mall, etc., and the at least one energy signal can be a Bluetooth radio signal, a WiFi radio signal, a mobile phone radio signal, a pulsating light signal, or an ultrasound signal, etc. The tagging unit 620 is coupled to the mobile device 602, and utilized for generating at least one tag associated with the at least one person carrying the mobile device 602 according to the at least one sensing signal. The database unit 650 is coupled to the tagging unit 620 and the control unit 640, and utilized for recording the at least one tag. The control unit 640 is coupled to the tagging unit 620 and the display units 630, 632, and 634, and utilized for controlling the display units 630, 632, and 634 to display at least one information according to the at least one tag recorded in the database unit 650, wherein the at least one information can be video, audio, or image, etc., which is for promotion, marketing, or advertisement, etc. Please note that the above embodiment is only for an illustrative purpose and is not meant to be a limitation of the present invention. For example, the numbers of the person, the mobile device, the energy-emitting unit, and the display unit can be changed according to different conditions. In addition, the tagging unit 620 and/or the control unit 640 can be implemented in a local system or in a cloud system. More specifically, the tagging unit 620 and/or the control unit 640 can be integrated in the mobile device 602. Moreover, the functions of the display units 630, 632, 634 can be replaced by the mobile device 602 when the design requirement of the location-based service delivering system 600 is making the mobile device 602 display the at least one information according to the at least one tag. In other words, the display units 630, 632, 634 can be integrated in the mobile device 602 or omitted in another embodiment.

For example, as shown in FIG. 11, when a person carrying the mobile device 602 is in a first position point P1 in a department store, the mobile device 602 will generate a sensing signal S1 by detecting an energy signal E1 emitted from the energy-emitting unit 610, and the mobile device 602 will generate a sensing signal S2 by detecting an energy signal E2 emitted from the energy-emitting unit 611, and the mobile device 602 will generate a sensing signal S3 by detecting an energy signal E3 emitted from the energy-emitting unit 612. The tagging unit 620 generates a first tag T1 corresponding to the first position point P1 and associated with a person carrying the mobile device 602 according to the sensing signal S1, S2, and S3, and the database unit 650 is utilized for recording the first tag T1, and the control unit 640 will control the display unit 630 to display a first information according to the first tag T1 recorded in the database unit 650, wherein the first information can be a video, an audio, or an image, etc., which is for promotion, marketing, or advertisement, etc.

Next, when a person carrying the mobile device 602 is in a second position point P6 in the department store, the mobile device 602 will generate a sensing signal S1 by detecting an energy signal E4 emitted from the energy-emitting unit 610, and the mobile device 602 will generate a sensing signal S3 by detecting an energy signal E5 emitted from the energy-emitting unit 612, and the mobile device 602 will generate a sensing signal S4 by detecting an energy signal E6 emitted from the energy-emitting unit 613, and the mobile device 602 will generate a sensing signal S5 by detecting an energy signal E7 emitted from the energy-emitting unit 614. The tagging unit 620 generates a second tag T6 corresponding to the second position point P6 and associated with the person carrying the mobile device 602 according to the sensing signal S1, S3, S4, and S5, and the database unit 650 is utilized for recording the second tag T6, and the control unit 640 will control the display unit 632 to display a second information according to the second tag T6 and/or the first tag T1 recorded in the database unit 650, wherein the second information can be a video, an audio, or an image, etc., which is for promotion, marketing, or advertisement, etc.

Next, when a person carrying the mobile device 602 is in a third position point P3 in the department store, the mobile device 602 will generate a sensing signal S4 by detecting an energy signal E8 emitted from the energy-emitting unit 613, and the mobile device 602 will generate a sensing signal S5 by detecting an energy signal E9 emitted from the energy-emitting unit 614. The tagging unit 620 generates a third tag T3 corresponding to the third position point P3 and associated with the person carrying the mobile device 602 according to the sensing signal S4 and S5, and the database unit 650 is utilized for recording the third tag T3, and the control unit 640 will control the display unit 634 to display a third information according to the third tag T3, the second tag T6, and/or the first tag T1 recorded in the database unit 650, wherein the third information can be a video, an audio, or an image, etc., which is for promotion, marketing, or advertisement, etc. Please note that the above embodiment is only for an illustrative purpose and is not meant to be a limitation of the present invention. For example, the numbers of the person, the mobile device, the energy-emitting unit, and the display unit can be changed according to different conditions.

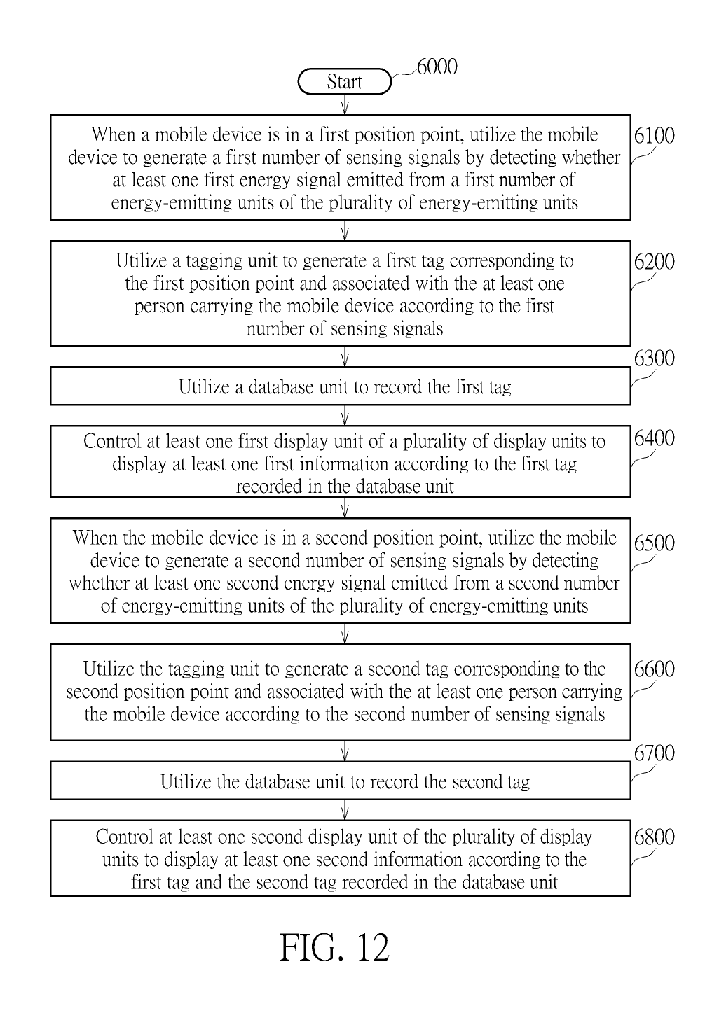

Please refer to FIG. 12. FIG. 12 is a flowchart showing a location-based service delivering method of an embodiment in accordance with the above operation schemes of the location-based service delivering system 600 in FIG. 11 of the present invention. Provided that substantially the same result is achieved, the steps of the process flowchart need not be in the exact order shown in FIG. 12 and need not be contiguous, that is, other steps can be intermediate. The location-based service delivering method in the sixth embodiment of the present invention comprises the following steps:

Step 6000: Start.

Step 6100: When a mobile device is in a first position point, utilize the mobile device to generate a first number of sensing signals by detecting whether at least one first energy signal emitted from a first number of energy-emitting units of the plurality of energy-emitting units.

Step 6200: Utilize a tagging unit to generate a first tag corresponding to the first position point and associated with the at least one person carrying the mobile device according to the first number of sensing signals.

Step 6300: Utilize a database unit to record the first tag.

Step 6400: Control at least one first display unit of a plurality of display units to display at least one first information according to the first tag recorded in the database unit.

Step 6500: When the mobile device is in a second position point, utilize the mobile device to generate a second number of sensing signals by detecting whether at least one second energy signal emitted from a second number of energy-emitting units of the plurality of energy-emitting units.

Step 6200: Utilize the tagging unit to generate a second tag corresponding to the second position point and associated with the at least one person carrying the mobile device according to the second number of sensing signals.

Step 6700: Utilize the database unit to record the second tag.

Step 6800: Control at least one second display unit of the plurality of display units to display at least one second information according to the first tag and the second tag recorded in the database unit.

Please note that the above embodiment is only for an illustrative purpose and is not meant to be a limitation of the present invention. For example, the number of the position points of the mobile device is not meant to be a limitation of the present invention. In addition, the tagging unit can be integrated in the mobile device. Moreover, the functions of the display units can be replaced by the mobile device when the design requirement of the location-based service delivering method is making the mobile device display the at least first and second information according to the at least one tag. In other words, the display units can be integrated in the mobile device in another embodiment.

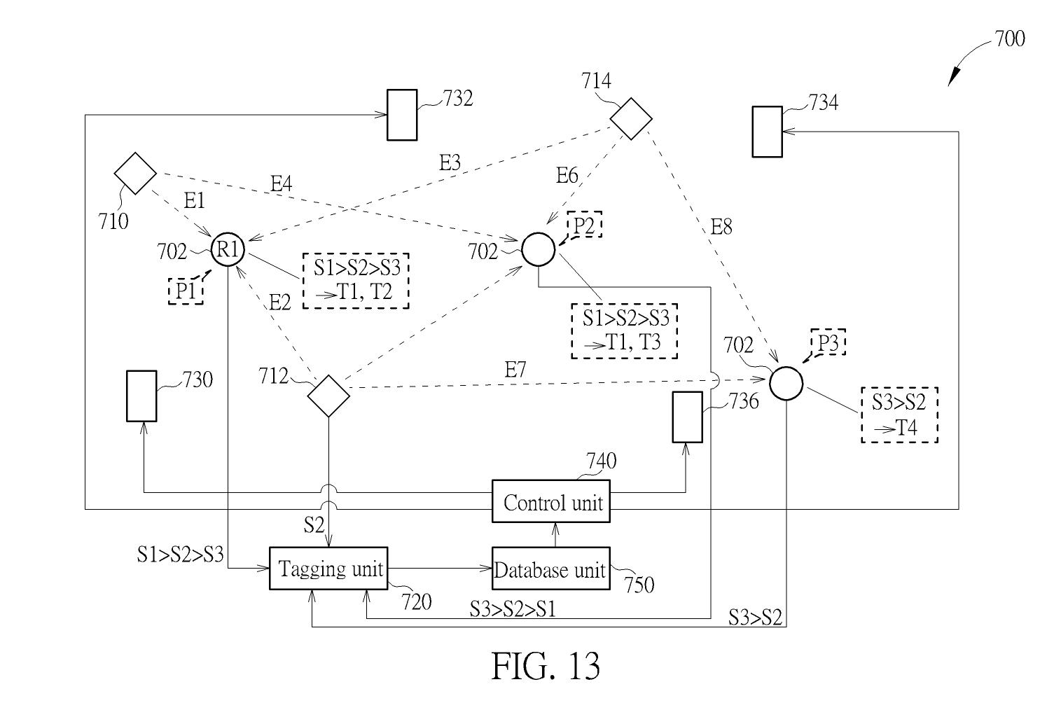

Please refer to FIG. 13. FIG. 13 shows a simplified block diagram of a location-based service delivering system 700 for at least one person carrying a mobile device 702 with a sensing function in accordance with a seventh embodiment of the present invention. As shown in FIG. 13, the location-based service delivering system 700 comprises: three energy-emitting units 710, 712, 714, a tagging unit 720, four display units 730, 732, 734, a control unit 740, and a database unit 750. The mobile device 702 is utilized for generating a plurality of sensing signals with different signal strengths or same signal strength by measuring at least one energy signal emitted from the energy-emitting units 710, 712, and 714, wherein the energy-emitting units 710, 712, and 714 can be disposed at fixed locations within a retail store, a department store, or a mall, etc., and the at least one energy signal can be a Bluetooth radio signal, a WiFi radio signal, a mobile phone radio signal, a pulsating light signal, or an ultrasound signal, etc. The tagging unit 720 is coupled to the mobile device 702, and utilized for generating at least one tag associated with the at least one person carrying the mobile device 702 according to the signal strengths of the plurality of sensing signals. The database unit 750 is coupled to the tagging unit 720 and the control unit 740, and utilized for recording the at least one tag. The control unit 740 is coupled to the tagging unit 720 and the display units 730, 732, and 734, and utilized for controlling the display units 730, 732, and 734 to display at least one information according to the at least one tag recorded in the database unit 750, wherein the at least one information can be video, audio, or image, etc., which is for promotion, marketing, or advertisement, etc. Please note that the above embodiment is only for an illustrative purpose and is not meant to be a limitation of the present invention. For example, the numbers of the person, the mobile device, the energy-emitting unit, and the display unit can be changed according to different conditions. In addition, the tagging unit 720 and/or the control unit 740 can be implemented in a local system or in a cloud system. More specifically, the tagging unit 720 and/or the control unit 740 can be integrated in the mobile device 702. Moreover, the functions of the display units 730, 732, 734, and 736 can be replaced by the mobile device 702 when the design requirement of the location-based service delivering system 700 is making the mobile device 702 display the at least one information according to the at least one tag. In other words, the display units 730, 732, 734, and 736 can be integrated in the mobile device 702 or omitted in another embodiment.

For example, as shown in FIG. 13, when a person carrying the mobile device 702 is in a first position point P1 in a department store, the mobile device 702 will generate a sensing signal S1 with a first signal strength by measuring an energy signal E1 emitted from the energy-emitting unit 710, and the mobile device 702 will generate a sensing signal S2 with a second signal strength by measuring an energy signal E2 emitted from the energy-emitting unit 712, and the mobile device 702 will generate a sensing signal S3 with a third signal strength by measuring an energy signal E3 emitted from the energy-emitting unit 714, wherein the first signal strength is higher than the second signal strength, and the second signal strength is higher than the third signal strength (i.e. S1>S2>S3), and the tagging unit 720 generates tags T1 and T2 corresponding to the first position point P1 and associated with a person carrying the mobile device 702 according to the signal strengths of the sensing signal S1, S2, and S3 (i.e. S1>S2>S3), and the database unit 750 is utilized for recording tags T1 and T2, and the control unit 740 will control the display units 730 and 732 to display a first information according to the tag combination (T1 and T2) recorded in the database unit 750, wherein the first information can be a video, an audio, or an image, etc., which is for promotion, marketing, or advertisement, etc.

Next, when a person carrying the mobile device 702 is in a second position point P2 in the department store, the mobile device 702 will generate a sensing signal S1 with a fourth signal strength by measuring an energy signal E4 emitted from the energy-emitting unit 710, and the mobile device 702 will generate a sensing signal S2 with a fifth signal strength by measuring an energy signal E5 emitted from the energy-emitting unit 712, and the mobile device 702 will generate a sensing signal S3 with a sixth signal strength by measuring an energy signal E6 emitted from the energy-emitting unit 714, wherein the sixth signal strength is higher than the fifth signal strength, and the fifth signal strength is higher than the fourth signal strength (i.e. S3>S2>S1), and the tagging unit 720 generates tags T1 and T3 corresponding to the second position point P2 and associated with a person carrying the mobile device 702 according to the signal strengths of the sensing signal S1, S2, and S3 (i.e. S3>S2>S1), and the database unit 750 is utilized for recording the tags T1 and T3, and the control unit 740 will control the display units 734 and 736 to display a second information according to the tag combination (T1 and T3) and/or (T1 and T2) recorded in the database unit 750, wherein the second information can be a video, an audio, or an image, etc., which is for promotion, marketing, or advertisement, etc.

Next, when a person carrying the mobile device 702 is in a third position point P7 in the department store, the mobile device 702 will generate a sensing signal S2 with a seventh signal strength by measuring an energy signal E3 emitted from the energy-emitting unit 712, and the mobile device 702 will generate a sensing signal S3 with an eighth signal strength by measuring an energy signal E8 emitted from the energy-emitting unit 714, wherein the eighth signal strength is higher than the seventh signal strength (i.e. S3>S2), and the tagging unit 720 generates a tag T4 corresponding to the second position point P2 and associated with a person carrying the mobile device 702 according to the signal strengths of the sensing signal S2 and S3 (i.e. S3>S2), and the database unit 750 is utilized for recording the tag T4, and the control unit 740 will control the display units 734 and 736 to display a third information according to the tag T4 and/or the tag combination (T1 and T3) and/or (T1 and T2) recorded in the database unit 750, wherein the third information can be a video, an audio, or an image, etc., which is for promotion, marketing, or advertisement, etc. Please note that the above embodiment is only for an illustrative purpose and is not meant to be a limitation of the present invention. For example, the numbers of the person, the mobile device, the energy-emitting unit, and the display unit can be changed according to different conditions.

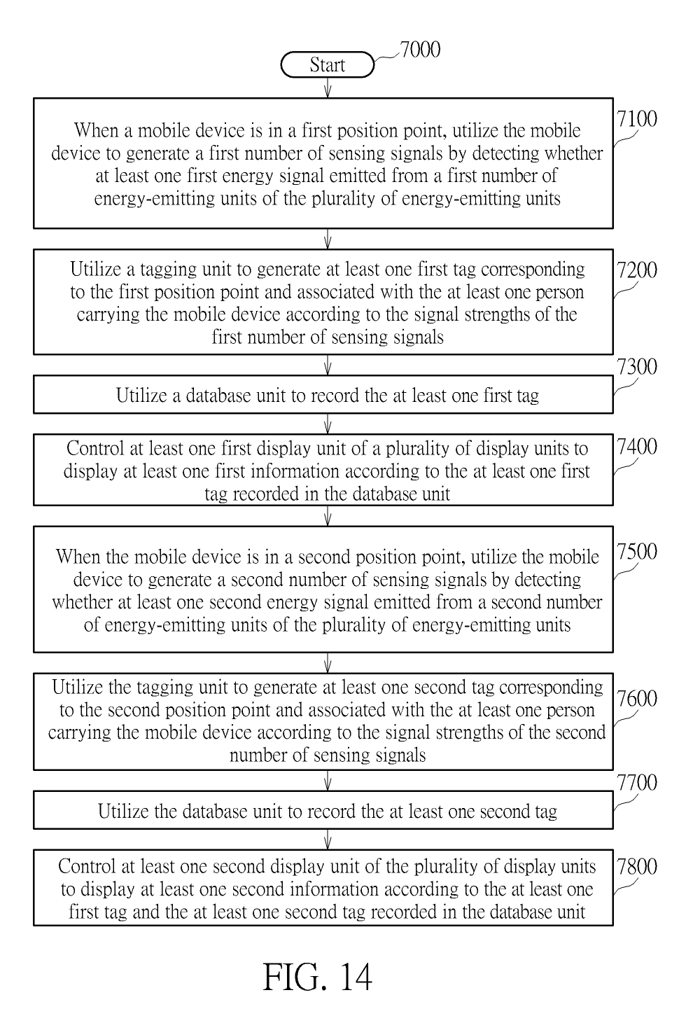

Please refer to FIG. 14. FIG. 14 is a flowchart showing a location-based service delivering method of an embodiment in accordance with the above operation schemes of the location-based service delivering system 700 in FIG. 13 of the present invention. Provided that substantially the same result is achieved, the steps of the process flowchart need not be in the exact order shown in FIG. 14 and need not be contiguous, that is, other steps can be intermediate. The location-based service delivering method in the seventh embodiment of the present invention comprises the following steps:

Step 7000: Start.

Step 7100: When a mobile device is in a first position point, utilize the mobile device to generate a first number of sensing signals by detecting whether at least one first energy signal emitted from a first number of energy-emitting units of the plurality of energy-emitting units.

Step 7200: Utilize a tagging unit to generate at least one first tag corresponding to the first position point and associated with the at least one person carrying the mobile device according to the signal strengths of the first number of sensing signals.

Step 7300: Utilize a database unit to record the at least one first tag.

Step 7400: Control at least one first display unit of a plurality of display units to display at least one first information according to the at least one first tag recorded in the database unit.

Step 7500: When the mobile device is in a second position point, utilize the mobile device to generate a second number of sensing signals by detecting whether at least one second energy signal emitted from a second number of energy-emitting units of the plurality of energy-emitting units.

Step 7600: Utilize the tagging unit to generate at least one second tag corresponding to the second position point and associated with the at least one person carrying the mobile device according to the signal strengths of the second number of sensing signals.

Step 7700: Utilize the database unit to record the at least one second tag.

Step 7800: Control at least one second display unit of the plurality of display units to display at least one second information according to the at least one first tag and the at least one second tag recorded in the database unit.

Please note that the above embodiment is only for an illustrative purpose and is not meant to be a limitation of the present invention. For example, the number of the position points of the mobile device is not meant to be a limitation of the present invention. In addition, the tagging unit can be integrated in the mobile device. Moreover, the functions of the display units can be replaced by the mobile device when the design requirement of the location-based service delivering method is making the mobile device display the at least first and second information according to the at least one tag. In other words, the display units can be integrated in the mobile device in another embodiment.

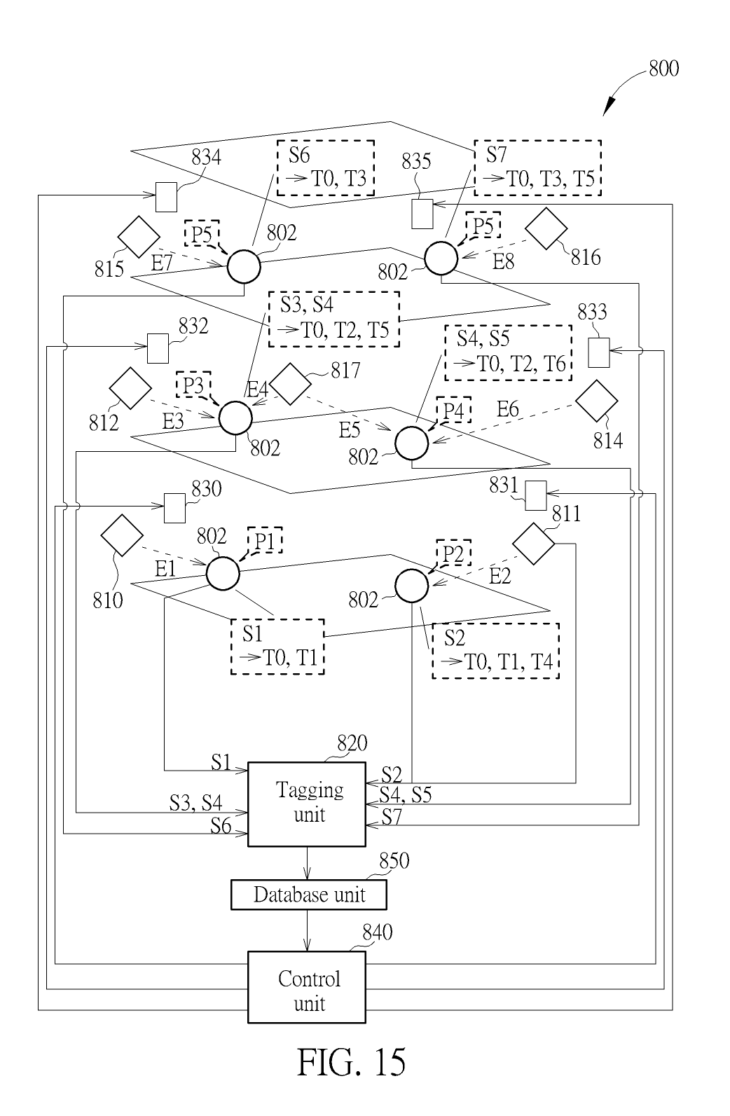

Please refer to FIG. 15. FIG. 15 shows a simplified block diagram of a location-based service delivering system 800 for at least one person carrying a mobile device 802 with a sensing function in accordance with a eighth embodiment of the present invention. As shown in FIG. 15, the location-based service delivering system 800 comprises: seven energy-emitting units 810, 811, 812, 813, 814, 815, 816, a tagging unit 820, six display units 830, 831, 832, 833, 834, 835, a control unit 840, and a database unit 850. The mobile device 802 is utilized for generating at least one sensing signal by sensing at least one energy signal emitted from the energy-emitting units 810, 811, 812, 813, 814, 815, and 816, wherein the energy-emitting units 810, 811, 812, 813, 814, 815, and 816 can be disposed at fixed locations within a retail store, a department store, or a mall, etc., and the at least one energy signal can be a Bluetooth radio signal, a WiFi radio signal, a mobile phone radio signal, a pulsating light signal, or an ultrasound signal, etc. The tagging unit 820 is coupled to the mobile device 802, and utilized for generating at least one tag associated with the at least one person carrying the mobile device 802 according to the plurality of sensing signals, wherein the at least one tag is pre-defined to be corresponding to a specific position or a specific area, such as a building, a specific floor of the building, or a specific area of the specific floor of the building. The database unit 850 is coupled to the tagging unit 820 and the control unit 840, and utilized for recording the at least one tag. The control unit 840 is coupled to the tagging unit 820 and the display units 830, 831, 832, 833, 834, and 835, and utilized for controlling the display units 830, 831, 832, 833, 834, and 835 to display at least one information according to the at least one tag recorded in the database unit 850, wherein the at least one information can be video, audio, or image, etc., which is for promotion, marketing, or advertisement, etc. Please note that the above embodiment is only for an illustrative purpose and is not meant to be a limitation of the present invention. For example, the numbers of the person, the mobile device, the energy-emitting unit, and the display unit can be changed according to different conditions. In addition, the tagging unit 820 and/or the control unit 840 can be implemented in a local system or in a cloud system. More specifically, the tagging unit 820 and/or the control unit 840 can be integrated in the mobile device 802. Moreover, the functions of the display units 830, 831, 832, 833, 834, and 835 can be replaced by the mobile device 802 when the design requirement of the location-based service delivering system 800 is making the mobile device 802 display the at least one information according to the at least one tag. In other words, the display units 830, 831, 832, 833, 834, and 835 can be integrated in the mobile device 802 or omitted in another embodiment.

For example, as shown in FIG. 15, there are seven tags T0, T1, T2, T3, T4, T5, and T6 pre-defined to be corresponding to a building, a specific floor of the building, and a specific area of the building, respectively, wherein the tag T0 is corresponding to a building of a department store, the tag T1 is corresponding to a first floor of the building of the department store, the tag T2 is corresponding to a second floor of the building of the department store, the tag T3 is corresponding to a third floor of the building of the department store, the tag T4 is corresponding to a cosmetics sales area of the department store, the tag T5 is corresponding to a furniture sales area of the department store, and the tag T6 is corresponding to a clothes sales area of the department store.

When a person carrying the mobile device 802 is in a first position point P1 in a department store, the energy-emitting unit 810 will generate a sensing signal S1 by detecting an energy signal E1 emitted from the mobile device 802, the tagging unit 820 generates the tag T0 corresponding to the building of a department store and the tag T1 corresponding to the first floor of the building of the department store associated with the person carrying the mobile device 802 according to the sensing signal S1, and the database unit 850 is utilized for recording the tags T0 and T1, and the control unit 840 will control the display unit 830 to display a first information according to the tag combination (T0 and T1) recorded in the database unit 850, wherein the first information can be a video, an audio, or an image, etc., which is for promotion, marketing, or advertisement, etc.

Next, when a person carrying the mobile device 802 is in a second position point P2 in the department store, the mobile device 802 will generate a sensing signal S2 by detecting an energy signal E2 emitted from the energy-emitting unit 811, and the tagging unit 820 generates the tag T0 corresponding to the building of a department store, the tag T1 corresponding to the first floor of the building of the department store, and the tag T4 corresponding to the cosmetics sales area of the department store associated with the person carrying the mobile device 802 according to the sensing signal S2, and the database unit 850 is utilized for recording the tags T0, T1, and T4, and the control unit 840 will control the display unit 831 to display a second information according to the tag combination (T0, T1, and T4) and/or (T0 and T1) recorded in the database unit 850, wherein the second information can be a video, an audio, or an image, etc., which is for promotion, marketing, or advertisement, etc.

Next, when a person carrying the mobile device 802 is in a third position point P3 in the department store, the mobile device 802 will generate a sensing signal S3 by detecting an energy signal E3 emitted from the energy-emitting unit 812 and the mobile device 802 will generate a sensing signal S4 by detecting an energy signal E4 emitted from the energy-emitting unit 813, and the tagging unit 820 generates the tag T0 corresponding to the building of a department store, the tag T2 corresponding to the second floor of the building of the department store, and the tag T5 corresponding to the furniture sales area of the department store associated with the person carrying the mobile device 802 according to the sensing signals S3 and S4, and the database unit 850 is utilized for recording the tags T0, T2, and T5, and the control unit 840 will control the display unit 832 to display a third information according to the tag combination (T0, T2, and T5), (T0, T1), and/or (T0, T1, and T4) recorded in the database unit 850, wherein the third information can be a video, an audio, or an image, etc., which is for promotion, marketing, or advertisement, etc.

Next, when a person carrying the mobile device 802 is in a fourth position point P8 in the department store, the mobile device 802 will generate a sensing signal S4 by detecting an energy signal E5 emitted from the energy-emitting unit 813 and the mobile device 802 will generate a sensing signal S5 by detecting an energy signal E6 emitted from the energy-emitting unit 814, and the tagging unit 820 generates the tag T0 corresponding to the building of a department store, the tag T2 corresponding to the second floor of the building of the department store, and the tag T6 corresponding to the clothes sales area of the department store associated with the person carrying the mobile device 802 according to the sensing signals S4 and S5, and the database unit 850 is utilized for recording the tags T0, T2, and T6, and the control unit 840 will control the display unit 833 to display a fourth information according to the tag combination (T0, T2, and T6), (T0, T2, and T5), (T0, T1), and/or (T0, T1, and T4) recorded in the database unit 850, wherein the fourth information can be a video, an audio, or an image, etc., which is for promotion, marketing, or advertisement, etc.

Next, when a person carrying the mobile device 802 is in a fifth position point P5 in the department store, the mobile device 802 will generate a sensing signal S6 by detecting an energy signal E7 emitted from the energy-emitting unit 815, and the tagging unit 820 generates the tag T0 corresponding to the building of a department store, the tag T3 corresponding to the third floor of the building of the department store associated with the person carrying the mobile device 802 according to the sensing signal S6, and the database unit 850 is utilized for recording the tags T0 and T3, and the control unit 840 will control the display unit 834 to display a fifth information according to the tag combination (T0, T3), (T0, T2, and T6), (T0, T2, and T5), (T0, T1), and/or (T0, T1, and T4) recorded in the database unit 850, wherein the fifth information can be a video, an audio, or an image, etc., which is for promotion, marketing, or advertisement, etc.

Next, when a person carrying the mobile device 802 is in a sixth position point P5 in the department store, the mobile device 802 will generate a sensing signal S7 by detecting an energy signal E8 emitted from the energy-emitting unit 816, and the tagging unit 820 generates the tag T0 corresponding to the building of a department store, the tag T3 corresponding to the third floor of the building of the department store, and the tag T5 corresponding to the furniture sales area of the department store associated with the person carrying the mobile device 802 according to the sensing signal S7, and the database unit 850 is utilized for recording the tags T0, T2, and T5, and the control unit 840 will control the display unit 835 to display a sixth information according to the tag combination (T0, T3, and T5), (T0, T3), (T0, T2, and T6), (T0, T2, and T5), (T0, T1), and/or (T0, T1, and T4) recorded in the database unit 850, wherein the sixth information can be a video, an audio, or an image, etc., which is for promotion, marketing, or advertisement, etc.

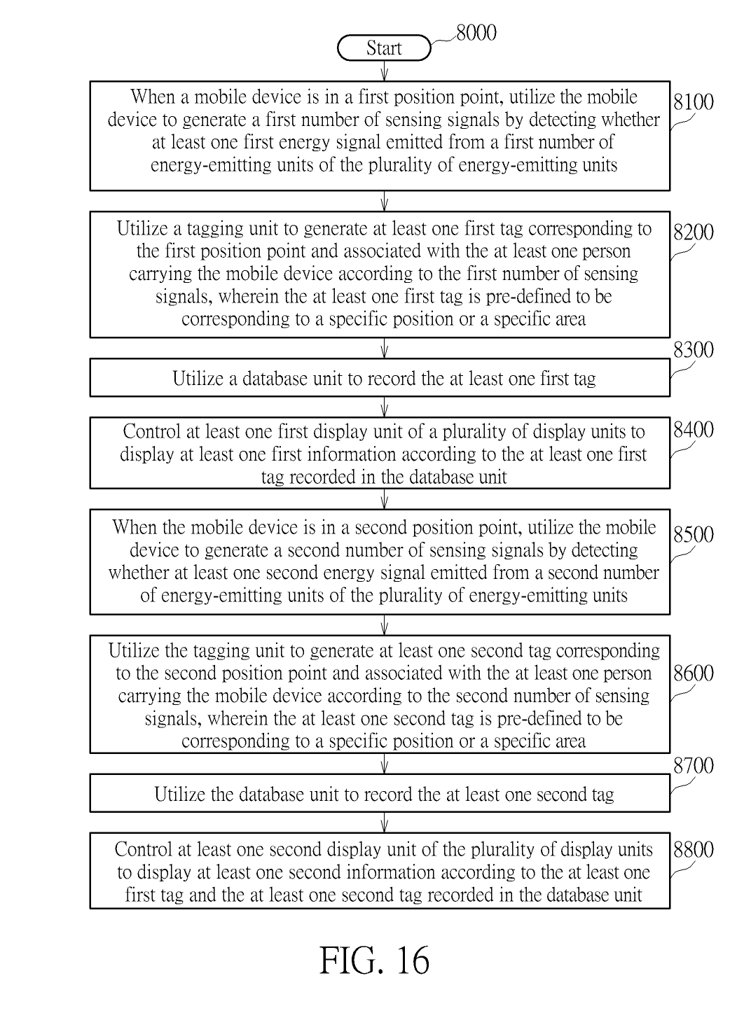

Please refer to FIG. 16. FIG. 16 is a flowchart showing a location-based service delivering method of an embodiment in accordance with the above operation schemes of the location-based service delivering system 800 in FIG. 15 of the present invention. Provided that substantially the same result is achieved, the steps of the process flowchart need not be in the exact order shown in FIG. 16 and need not be contiguous, that is, other steps can be intermediate. The location-based service delivering method in the eighth embodiment of the present invention comprises the following steps:

Step 8000: Start.

Step 8100: When a mobile device is in a first position point, utilize the mobile device to generate a first number of sensing signals by detecting whether at least one first energy signal emitted from a first number of energy-emitting units of the plurality of energy-emitting units.

Step 8200: Utilize a tagging unit to generate at least one first tag corresponding to the first position point and associated with the at least one person carrying the mobile device according to the first number of sensing signals, wherein the at least one first tag is pre-defined to be corresponding to a specific position or a specific area.

Step 8300: Utilize a database unit to record the at least one first tag.

Step 8400: Control at least one first display unit of a plurality of display units to display at least one first information according to the at least one first tag recorded in the database unit.

Step 8500: When the mobile device is in a second position point, utilize the mobile device to generate a second number of sensing signals by detecting whether at least one second energy signal emitted from a second number of energy-emitting units of the plurality of energy-emitting units.

Step 8600: Utilize the tagging unit to generate at least one second tag corresponding to the second position point and associated with the at least one person carrying the mobile device according to the second number of sensing signals, wherein the at least one second tag is pre-defined to be corresponding to a specific position or a specific area.

Step 8700: Utilize the database unit to record the at least one second tag.

Step 8800: Control at least one second display unit of the plurality of display units to display at least one second information according to the at least one first tag and the at least one second tag recorded in the database unit.

Please note that the above embodiment is only for an illustrative purpose and is not meant to be a limitation of the present invention. For example, the number of the position points of the mobile device is not meant to be a limitation of the present invention. In addition, the tagging unit can be integrated in the mobile device. Moreover, the functions of the display units can be replaced by the mobile device when the design requirement of the location-based service delivering method is making the mobile device display the at least first and second information according to the at least one tag. In other words, the display units can be integrated in the mobile device in another embodiment.

Briefly summarized, the location-based service delivering system and the location-based service delivering method for at least one person carrying an energy-emitting mobile device or a mobile device having a sensing function disclosed by the present invention can use an innovative tagging scheme for the delivery of location-based services and allow the delivery of location-based services without using the earth coordinates. In one scenario, a person carrying an energy-emitting device, such as a mobile phone, can be detected by a plurality of sensing devices installed at fixed locations within a department store, for example. Each sensing device may be associated with at least a semantic tag, such as a name of a retail store, or a brand of a product sold near the receiving station. The person carrying the radio transmitting device is labeled with these tags as he visits different regions of the department store. Then a database of rules may be programmed so that, when the tags of a person carrying the radio transmitting device match sequences in the database, an action is taken where an advertisement is pushed to the person's mobile phone or a screen near the person, for example. In another scenario where the direction of the energy signal is reversed, energy-emitting devices may be installed throughout a store, where each energy-emitting device is associated with at least a semantic tag, such as the name of the store or the brand of the product sold near the transmitter. A person carrying a mobile phone walking around a store may pick up multiple tags. When the sequence of tags matches a previously specified pattern, an action is trigger to play a video on a screen near the person, or to push a message to the person's mobile phone.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A location-based service delivering system for at least one person carrying a mobile device with a sensing function, comprising:
at least one energy-emitting unit, for emitting at least one energy signal, wherein the mobile device generates at least one sensing signal by sensing the at least one energy signal emitted from the at least one energy-emitting unit;
a tagging unit, coupled to the mobile device, for generating at least one tag associated with the at least one person carrying the mobile device according to the at least one sensing signal;
at least one display unit; and
a control unit, coupled to the tagging unit and the at least one display unit, for controlling the display unit to display at least one information according to the at least one tag generated by the tagging unit.

2. The location-based service delivering system of claim 1, further comprising:
a database unit, coupled to the tagging unit and the control unit, for recording the at least one tag;
wherein the control unit controls the display unit to display at least one information according to the at least one tag recorded in the database unit.

3. The location-based service delivering system of claim 2, wherein the location-based service delivering system comprises a plurality of energy-emitting units and a plurality of display units.

4. The location-based service delivering system of claim 3, wherein when the mobile device is in a first position point, the mobile device generates a first number of sensing signals by detecting whether at least one first energy signal emitted from a first number of energy-emitting units of the plurality of energy-emitting units, and the tagging unit generates a first tag corresponding to the first position point and associated with the at least one person carrying the mobile device according to the first number of sensing signals, and the database unit records the first tag, and the control unit controls at least one first display unit of the plurality of display units to display at least one first information according to the first tag recorded in the database unit.

5. The location-based service delivering system of claim 4, wherein when the mobile device is in a second position point, the mobile device generates a second number of sensing signals by detecting whether at least one second energy signal emitted from a second number of energy-emitting units of the plurality of energy-emitting units, and the tagging unit generates a second tag corresponding to the second position point and associated with the at least one person carrying the mobile device according to the second number of sensing signals, and the database unit records the second tag, and the control unit controls at least one second display unit of the plurality of display units to display at least one second information according to the first tag and the second tag recorded in the database unit.

6. The location-based service delivering system of claim 3, wherein when the mobile device is in a first position point, the mobile device generates a first number of sensing signals with different signal strengths or same signal strength by measuring at least one first energy signal emitted from a first number of energy-emitting units of the plurality of energy-emitting units, and the tagging unit generates at least one first tag corresponding to the first position point and associated with the at least one person carrying the mobile device according to the signal strengths of the first number of sensing signals, and the database unit records the at least one first tag, and the control unit controls at least one first display unit of the plurality of display units to display at least one first information according to the at least one first tag recorded in the database unit.

7. The location-based service delivering system of claim 6, wherein when the mobile device is in a second position point, the mobile device generates a second number of sensing signals with different signal strengths or same signal strength by measuring at least one second energy signal emitted from a second number of energy-emitting units of the plurality of energy-emitting units, and the tagging unit generates at least one second tag corresponding to the second position point and associated with the at least one person carrying the mobile device according to the signal strengths of the second number of sensing signals, and the database unit records the at least one second tag, and the control unit controls at least one second display unit of the plurality of display units to display at least one second information according to the at least one first tag and the at least one second tag recorded in the database unit.

8. The location-based service delivering system of claim 1, wherein the at least one tag is pre-defined to be corresponding to a specific position or a specific area.

9. The location-based service delivering system of claim 1, wherein the at least one energy-emitting unit is disposed at a fixed location.

10. The location-based service delivering system of claim 1, wherein the at least one energy signal is a Bluetooth radio signal, a WiFi radio signal, a mobile phone radio signal, a pulsating light signal, or an ultrasound signal.

11. The location-based service delivering system of claim 1, wherein the information is a video, an audio, or an image.

12. The location-based service delivering system of claim 1, wherein the tagging unit, the at least one display unit, or the control unit is integrated in the mobile device.

13. A location-based service delivering method for at least one person carrying a mobile device with a sensing function, comprising:
utilizing the mobile device to generate at least one sensing signal by sensing at least one energy signal emitted from at least one energy-emitting unit;
utilizing a tagging unit for generating at least one tag associated with the at least one person carrying the mobile device according to the at least one sensing signal; and
controlling at least one display unit to display at least one information according to the at least one tag generated by the tagging unit.

14. The location-based service delivering method of claim 13, further comprising:
utilizing a database unit for recording the at least one tag;
wherein the step of controlling the at least one display unit comprises controlling the at least one display unit to display at least one information according to the at least one tag recorded in the database unit.

15. The location-based service delivering method of claim 14, wherein when the mobile device is in a first position point, the location-based service delivering method further comprises:
utilizing the mobile device to generate a first number of sensing signals by detecting whether at least one first energy signal emitted from a first number of energy-emitting units of the plurality of energy-emitting units;
utilizing the tagging unit to generate a first tag corresponding to the first position point and associated with the at least one person carrying the mobile device according to the first number of sensing signals;
utilizing the database unit to record the first tag; and
controlling at least one first display unit of the plurality of display units to display at least one first information according to the first tag recorded in the database unit.

16. The location-based service delivering method of claim 15, wherein when the mobile device is in a second position point, the location-based service delivering method further comprises:
utilizing the mobile device to generate a second number of sensing signals by detecting whether at least one second energy signal emitted from a second number of energy-emitting units of the plurality of energy-emitting units;
utilizing the tagging unit to generate a second tag corresponding to the second position point and associated with the at least one person carrying the mobile device according to the second number of sensing signals;
utilizing the database unit to record the second tag; and
controlling at least one second display unit of the plurality of display units to display at least one second information according to the first tag and the second tag recorded in the database unit.

17. The location-based service delivering method of claim 14, wherein when the mobile device is in a first position point, the location-based service delivering method further comprises:
utilizing the mobile device to generate a first number of sensing signals with different signal strengths or same signal strength by measuring at least one first energy signal emitted from a first number of energy-emitting units of the plurality of energy-emitting units;
utilizing the tagging unit to generate at least one first tag corresponding to the first position point and associated with the at least one person carrying the mobile device according to the signal strengths of the first number of sensing signals;
utilizing the database unit to record the at least one first tag; and
controlling at least one first display unit of the plurality of display units to display at least one first information according to the at least one first tag recorded in the database unit.

18. The location-based service delivering method of claim 17, wherein when the mobile device is in a second position point, the location-based service delivering method further comprises:
utilizing the mobile device to generate a second number of sensing signals with different signal strengths or same signal strength by measuring at least one second energy signal emitted from a second number of energy-emitting units of the plurality of energy-emitting units;
utilizing the tagging unit to generate at least one second tag corresponding to the second position point and associated with the at least one person carrying the mobile device according to the signal strengths of the second number of sensing signals;
utilizing the database unit to record the at least one second tag; and
controlling at least one second display unit of the plurality of display units to display at least one second information according to the at least one first tag and the at least one second tag recorded in the database unit.

19. The location-based service delivering method of claim 13, wherein the at least one tag is pre-defined to be corresponding to a specific position or a specific area.

20. The location-based service delivering method of claim 13, wherein the at least one energy signal is a Bluetooth radio signal, a WiFi radio signal, a mobile phone radio signal, a pulsating light signal, or an ultrasound signal.
